(19) United States
(12) Patent Application Publication
(10) Pub. No.: US 2014/0051780 A1
(43) Pub. Date: Feb. 20, 2014

(54) COPOLYESTERS HAVING REPEAT UNITS DERIVED FROM w-HYDROXY FATTY ACIDS

(71) Applicant: Richard A. Gross, East Plainview, NY (US)

(72) Inventor: Richard A. Gross, East Plainview, NY (US)

(73) Assignee: SyntheZyme LLC, Brooklyn, NY (US)

(21) Appl. No.: 13/587,292

(22) Filed: Aug. 16, 2012

(51) Int. Cl. C08G 63/06

(52) U.S. Cl. CPC C08G 63/06
USPC 521/182; 528/302; 528/279; 528/283; 528/293; 524/600

(57) ABSTRACT

The present invention relates to aliphatic or aliphatic-aromatic polyesters and copolyesters comprised of biobased ω-hydroxyfatty acids or derivatives thereof, processes for the preparation thereof, and compositions thereof having improved properties. The copolyesters of the present invention may also contain additional components that can be selected from aliphatic or aromatic diacids, diols and hydroxyacids obtained from synthetic and natural sources. The biobased ω-hydroxyfatty acids that comprise the polyesters and copolyesters of the present invention are made using a fermentation process from pure fatty acids, fatty acid mixtures, pure fatty acid ester, mixtures of fatty acid esters, and triglycerides from various sources. The polyesters of the present invention may contain various amounts and types of ω-carboxyfatty acids depending on the engineered yeast strain used for the bioconversion as well as the feedstock(s) used.

### FIELD OF THE INVENTION

The present invention relates to aliphatic or aliphatic-aromatic polyesters and copolyesters comprised of biobased ω-hydroxyfatty acids or derivatives of such materials, processes for the preparation of such polyesters and copolyesters, and compositions thereof having improved properties.

### BACKGROUND

The preparation of aliphatic copolyesters comprising diacids and diols was reported in the mid-1930's as described in U.S. Pat. No. 2,012,267, which is incorporated herein by reference in its entirety. Since that time, there has been a tremendous amount of work performed in the field of polyesters. A very high percentage of the work on polyesters has been carried out on aromatic polyesters and copolyesters, such as poly(ethylene terephthalate), because of their high melting points, high glass transition temperatures, good barrier properties, high tensile strengths and other useful properties. While, in general, aromatic polyesters have superior physical properties to aliphatic polyesters, aromatic polyesters are not rapidly biodegradable. Aliphatic polyesters on the other hand, are generally considered to be rapidly biodegradable. For example, U.S. Pat. No. 3,932,319, which is incorporated herein by reference in its entirety, broadly discloses blends of aliphatic polyesters and naturally occurring biodegradable materials.

Aliphatic polyesters and copolyesters are a group of biodegradable polymers that may be synthesized from readily renewable building blocks such as lactic acid and fatty acid-derived materials. Such polyesters are synthesized via polycondensation reactions between aliphatic dicarboxylic acids with diols, transesterification of diesters with diols, polymerization of hydroxy acids, and ring-opening polymerization of lactones. Resulting products can be used in industrial and biomedical applications such as for controlled release drug carriers, implants and surgical sutures. Moreover, polyesters with functional groups along chains or in pendant groups are attracting increased interest since these groups can be used to regulate polymeric material properties. Furthermore, functional polymers can be post-modified to attach biologically active groups that allow the preparation of biomaterials for use in drug delivery systems and as scaffold materials for tissue engineering. Polymers from ricinoleic acid have proved highly valuable for controlled drug delivery systems. However, high purity ricinoleic acid is extremely expensive to make due to difficulties in its purification from the natural mixture.

Historically, α,ω-dicarboxylic acids were almost exclusively produced by chemical conversion processes. However, the chemical processes for production of α,ω-dicarboxylic acids from non-renewable petrochemical feedstocks usually produces numerous unwanted byproducts, requires extensive purification and gives low yields (See, for example, Picataggio et al., 1992, Bio/Technology 10, 894-898). Moreover, α,ω-dicarboxylic acids with carbon chain lengths greater than 13 atoms are not readily available by chemical synthesis. While several chemical routes to synthesize long-chain α,ω-dicarboxylic acids are available, their synthesis is difficult, costly and requires toxic reagents. Furthermore, other than four-carbon α,ω-unsaturated diacids (e.g. maleic acid and fumaric acid), longer chain unsaturated α,ω-dicarboxylic acids or those with other functional groups are difficult to obtain on a large commercial scale because the chemical oxidation often used to obtain them cleaves the unsaturated bonds or modifies them resulting in cis-trans isomerization (and other) by-products. In one example described by Olsen and Sheares in “Preparation of unsaturated linear aliphatic polyesters using condensation polymerization,” Macromolecules, 2006, 39, 8, 2808-2814, trans-β-hydromuconic acid (HMA) was selected for study since it is a commercially available unsaturated monomer that lacks the conjugation of shorter chain analogs (e.g. fumaric acid).

Many microorganisms have the ability to produce α,ω-dicarboxylic acids when cultured in n-alkanes and fatty acids, including Candida tropicalis, Candida cloacae, Cryptococcus neoforman and Corynebacterium sp. (Shiio et al., 1971, Agr. Biol. Chem. 35, 2033-2042; Hill et al., 1986, Appl. Microbiol. Biotech. 24: 168-174; and Broadway et al., 1993, J. Gen. Microbiol. 139, 1337-1344). Candida tropicalis and similar yeasts are known to produce α,ω-dicarboxylic acids with carbon lengths from C12 to C22 via an ω-oxidation pathway. The terminal methyl group of n-alkanes or fatty acids is first hydroxylated by a membrane-bound enzyme complex consisting of cytochrome P450 monooxygenase and associated NADPH cytochrome reductase, which is the rate-limiting step in the ω-oxidation pathway. Two additional enzymes, the fatty alcohol oxidase and fatty aldehyde dehydrogenase, further oxidize the alcohol to create ω-aldehyde acid and then the corresponding α,ω-dicarboxylic acid (Eschenfeldt et al., 2003, App!. Environ. Microbiol. 69, 5992-5999). However, there is also α-oxidation pathway for fatty acid oxidation that exists within Candida tropicalis. Both fatty acids and α,ω-dicarboxylic acids in wild type Candida tropicalis are efficiently degraded after activation to the corresponding acylCoA ester through the ω-oxidation pathway, leading to carbon-chain length shortening, which results in the low yields of α,ω-dicarboxylic acids and numerous by-products.

Mutants of C. tropicalis in which the ω-oxidation of fatty acids is impaired may be used to improve the production of α,ω-dicarboxylic acids (Uemura et al., 1988, J. Am. Oil. Chem. Soc. 64, 1254-1257; and Yi et al., 1989, Appl. Microbiol. Biotech. 30, 327-331). Genetically modified strains of the yeast Candida tropicalis have been developed to increase the production of α,ω-dicarboxylic acids. An engineered Candida tropicalis (Strain H5343, ATCC No. 20962) with the POX4 and POX5 genes that code for enzymes in the first step of fatty acid ω-oxidation disrupted was generated to prevent the yeast from metabolizing fatty acids, which directs the metabolic flux toward ω-oxidation and results in the accumulation of α,ω-dicarboxylic acids. See U.S. Pat. No. 5,254,466 and Picataggio et al., 1992, Bio/Technology 10: 894-898, each of which is hereby incorporated by reference herein in their entireties. Furthermore, by introduction of multiple copies of cytochrome P450 and reductase genes into C. tropicalis in which the ω-oxidation pathway is blocked, the C. tropicalis strain AR40 was generated with increased ω-hydroxylase activity and higher specific productivity of diacids from long-chain fatty acids. See, Picataggio et al., 1992, Bio/Technology 10: 894-898 (1992); and U.S. Pat. No. 5,620,878, each of which is hereby incorporated by reference herein in their entireties. Although the mutants or genetically modified C. tropicalis strains have been used for the biotransformation of saturated fatty acids (C12-C18) and unsaturated fatty acids with one or two double bonds to their corresponding diacids, the range of substrates needs to be expanded to produce more valuable diacids that are currently unavailable commercially, especially for those with internal functional groups that can be used for the potential biomaterial applications. The production of dicarboxylic acids by fermentation of saturated or unsaturated n-alkanes, n-alkenes, fatty acids or their esters with carbon number of 12 to 18 using a strain of the species C. tropicalis or other special microorganisms has been disclosed in U.S. Pat. Nos. 3,975,234; 4,339,536; 4,474,882; 5,254,466; and 5,620,878.

The copolyesters of the present invention comprise ω-hydroxyfatty acids and, therefore, have primary instead of secondary hydroxyl groups. As a consequence, they have increased reactivity over corresponding hydroxyfatty acids with internal or secondary hydroxyl groups, such as ricinoleic acid (12-Hydroxy-9-cis-octadecenoic acid) and 12-hydroxystearic acid, for esterification and urethane synthesis. Furthermore, polyesters from ricinoleic acid and 12-hydroxystearic acid have alkyl pendant groups that decrease material crystallinity and melting points. As such, ω-hydroxyfatty acids can replace ricinoleic acid and 12-hydroxystearic acid in certain copolymer applications requiring higher performance. Owing to their unique attributes, functional ω-hydroxy fatty acids of the present invention can be used in a wide variety of applications including as monomers to prepare next generation polyethylene-like poly(hydroxyalkanoates), surfactants, emulsifiers, cosmetic ingredients and lubricants. ω-Hydroxyfatty acids can also serve as precursors for vinyl monomers used in a wide-variety of carbon back bone polymers. Direct polymerization of ω-hydroxy fatty acids via condensation polymerization gives next generation polyethylene-like polyhyroxyalkanoates that can be used for a variety of commodity plastic applications. Alternatively, the copolyesters of the present invention can be designed for use as novel bioresorbable medical materials. Functional groups along polymers provide sites to bind or chemically link bioactive moieties to regulate the biological properties of these materials. Another use of functional polyesters is in industrial coating formulations, components in drug delivery vehicles and scaffolds that support cell growth during tissue engineering and other regenerative medicine strategies.

Despite 75 years of research on microbial production of poly(hydroxyalkanoates) (PHAs), and about 25 years of intense industrial interest, microbial PHAs have yet to be produced in large scale production. The lack of microbial PHA commercialization thus far is attributed to the high production and product recovery costs, difficulties in achieving desired material performance and a narrow thermal processing window that makes it difficult to convert PHAs to desired products by basic extrusion, injection molding and blown film processing. A recent major commercial effort to manufacture PHAs on an industrial scale has been undertaken in a joint venture between Archer Daniels Midland (ADM) and Metabolix Inc. (See, for example, U.S. Pat. No. 6,770,464 entitled “Methods for producing poly(hydroxy) fatty acids in bacteria” and U.S. Pat. No. 6,759,219 entitled “Methods for the biosynthesis of polyesters”). Microbial PHAs are formed within cells to produce specific polymer compositions with corresponding physical properties. Beyond what can be achieved by changing the physiological conditions of fermentations, further manipulation of the polymer product structure requires a re-engineering of intracellular enzymes involved in polymer synthesis, which is costly and time consuming. As a result, this limitation restricts the range of polymer structures and corresponding material properties that can be derived from microbial PHA manufacturing processes. Furthermore, it is difficult to obtain microbial PHAs that are sufficiently pure to be processed into articles of commerce without discoloration and other undesirable side reactions. This is due to the difficulties of separating microbial PHAs from other associated cellular materials such as proteins. Indeed, proteins are found within and outside microbial PHA granules and their removal is problematic. The need for further purification of microbial PHAs has prompted the use of undesirable solvent extraction procedures following microbial PHA synthesis. Typically, chlorinated solvents are used to extract products from cells, and the microbial PHAs are then precipitated. Several other purification methods have been developed, such as sodium hypochlorite treatments for the differential digestion of non-PHA cellular materials; however, such treatment causes severe degradation of the PHAs resulting in a reduction in their molecular weight.

In contrast, the process of the present invention provides for the synthesis of monomer ω-hydroxyfatty acids by fermentation and then carrying out subsequent chemical polymerizations (for example the synthesis of PHAs) using ω-hydroxyfatty acid monomers obtained by fermentation. Significant advantages are realized by this approach relative to the above described combination microbial synthesis of both monomer and polymer. Key advantages of the present invention are as follows: i) ω-hydroxyfatty acids are excreted outside of cells, thus simplifying their isolation from other cellular material, ii) since only monomer products are produced, these monomers can be copolymerized with a wide range of bioderived or petrochemical derived monomers to manufacture a diverse range of polymer products. The strategy of bioproduction of monomers that are subsequently polymerized by chemical methods has been successfully implemented to produce commercial products such as poly(propyleneterephtalate), poly(lactic) acid and others. See, for example, Robert W. Lenz and Robert H. Marchessault, “Bacterial Polyesters: Biosynthesis, Biodegradable Plastics and Biotechnology,” Biomacromolecules, 2005, 6 (1), pp 1-8, and other examples described herein.

Several ω-hydroxyfatty acid polyesters have previously been described. Veld et al. J. Polym. Sci., Part A: Polym. Chem. 2007, 45, 5968-5978, investigated aleuritic acid, having two secondary and one primary (ill-position) hydroxyl groups. Aleuritic acid is derived from ambrettolide, which naturally occurs in musk abrette seed oil and is a valuable perfume base due to its desirable odor. Aleuritic acid was first converted to its isopropyl ester and then polymerized (90° C., 550 m bar, 21 h) in a mixture of dry toluene and dry 2,4-dimethyl-3-pentanoi. Poly(aleuriteate) (Mn 5600 g/mol, PDI=3.2) was isolated in moderate yield (43%) after precipitation. The polymerization was highly selective for monomer primary hydroxyl groups with no observable secondary hydroxyl esterification based on NMR studies. In addition, Yang, et al., “Two-Step Biocatalytic Route to Biobased Functional Polyesters from ω-Carboxy Fatty Acids and Diols,” Biomacromolecules, 11(1), 259-68, described the formation of biobased polyesters catalyzed using immobilized Candida antarctica Lipase B (N435) as catalyst. The polycondensations with diols were performed in bulk as well as in diphenyl ether. The biobased ω-carboxy fatty acid monomers 1,18-cis-9-octadecenedioic, 1,22-cis-9-docosenedioic, and 1,18-cis-9,10-epoxy-octadecanedioic acids were synthesized in high conversion yields from oleic, erucic and epoxy stearic acids by whole-cell biotransformations catalyzed by C. tropicalis ATCC20962.

### SUMMARY OF THE INVENTION

The present invention relates to aliphatic or aliphatic-aromatic polyesters and copolyesters comprised of biobased ω-hydroxyfatty acids or derivatives of such materials, processes for the preparation of such polyesters and copolyesters, and compositions thereof having improved properties. The copolyesters of the present invention may also contain additional components that can be selected from aliphatic or aromatic diacids, diols and hydroxyacids obtained from synthetic and natural sources. The biobased ω-hydroxyfatty acids that comprise the polyesters and copolyesters of the present invention are made using a fermentation process from pure fatty acids, fatty acid mixtures, pure fatty acid ester, mixtures of fatty acid esters, and triglycerides from various sources. The polyesters of the present invention may contain various amounts and types of ω-carboxyfatty acids depending on the engineered yeast strain used for the bioconversion as well as the feedstock(s) used.

One embodiment of the present invention is a process for preparing an aliphatic or aliphatic/aromatic copolyester comprising the steps of: (i) admixing one or more ω-hydroxyfatty acids or an ester thereof, produced by fermentation of a feedstock using an engineered yeast strain, with one or more diacids or an ester thereof, one or more diols in a molar amount equal to the one or more diacids, one or more hydroxyacids and optionally an additive that is a member selected from the group consisting of a branching agent, an ion-containing monomer, and a filler; (ii) heating the mixture in the presence of one or more catalysts to between about 180 DC to about 300 DC; and (iii) recovering the copolyester material.

Another embodiment of the present invention is a process for preparing an aliphatic or aliphatic/aromatic copolyester which comprises the steps of: (i) preparing one or more ω-hydroxyfatty acids by fermentation of a feedstock using an engineered yeast strain; (ii) optionally preparing one or more ω-hydroxyfatty acid esters from the one or more ω-hydroxyfatty acids; (iii) admixing the one or more ω-hydroxyfatty acids or an ester thereof with one or more diacids or an ester thereof, one or more diols in a molar amount equal to the one or more diacids, and optionally an additive that is a member selected from the group consisting of a branching agent, an ion-containing monomer, and a filler; (iv) heating the mixture in the presence of one or more catalysts to between about 180 DC to about 300 DC; and (v) recovering the copolyester material.

Yet another embodiment of the present invention is a process for preparing an aliphatic or aliphatic/aromatic copolyester which comprises the steps of: (i) preparing one or more ω-hydroxyfatty acids by fermentation of a feedstock using an engineered yeast strain; (ii) preparing one or more ω-hydroxyfatty acid lactones or ω-hydroxyfatty acid lactone multimers from the one or more ω-hydroxyfatty acids; (iii) admixing the one or more ω-hydroxyfatty acid lactones or ω-hydroxyfatty acid lactone multimers with one or more diacids or an ester thereof, one or more diols in a molar amount equal to the one or more diacids, and optionally an additive that is a member selected from the group consisting of a branching agent, an ion-containing monomer, and a filler; (iv) heating the mixture in the presence of one or more catalysts; and (v) recovering the copolyester material.

A preferred embodiment of the present invention is a process wherein the one or more diacids or an ester thereof is an ω-carboxyfatty acid or an ester thereof obtained by fermentation of a feedstock using an engineered yeast strain.

Another preferred embodiment of the present invention is a process which comprises heating the mixture for a second time to between about 180° C. to about 260° C. under reduced pressure after the heating step, and a further process wherein the reduced pressure is between about 0.05 to about 2 mmHg.

Yet another preferred embodiment of the present invention is a process wherein the one or more ω-hydroxyfatty acids or an ester thereof is a lactone or macro lactone multimer of the ω-hydroxyfatty acid.

A preferred embodiment of the present invention is a process which comprises selecting the feedstock from a pure fatty acid, a mixture of fatty acids, a pure fatty acid ester, a mixture of fatty acid esters and triglycerides, or a combination thereof.

Another preferred embodiment of the present invention is a process wherein the engineered strain of yeast is an engineered strain of Candida tropicalis, and even more preferred is a process wherein the engineered strain of Candida tropicalis is selected from Candida tropicalis strains DP!, DP390, DP415, DP417, DP421, DP423, DP434 and DP436.

One embodiment of the present invention is a process wherein the catalyst is selected from a salt or oxide of Li, Ca, Mg, Mn, Zn, Pb, Sb, Sn, Ge, and Ti, a further process wherein the salt is an acetate salt, an oxide selected from an alkoxide or glycol adduct and a process of where the catalyst is titanium tetraisopropoxide, titanium tetraethoxide, titanium tetrabutoxide, titanium tetrachloride or stannous octanoate.

A preferred embodiment of the present invention is a process wherein the ω-hydroxyfatty acids is a member selected from the group consisting of ω-hydroxylauric acid (ω-OH-LA), ω-hydroxymyristic acid (ω-OH-MA), ω-hydroxypalmitic acid (ω-OH-PA), ω-hydroxy palmitoleic acid (ω-OH-POA), ω-hydroxystearic acid (ω-OH-SA), ω-hydroxyoleic acid (ω-OH-OA), ω-hydroxyricinoleic acid (ω-OH-RA), ω-hydroxylinoleic acid (ω-OH-LA), ω-hydroxy-α-linolenic acid, (ω-OH-ALA), ω-hydroxy-γ-linolenic acid (ω-OH-GLA), ω-hydroxybehenic acid (ω-OHBA) and ω-hydroxyerucic acid (ω-OH-EA).

Another preferred embodiment of the present invention is a process which comprises partially or completely hydrogenating the feedstock prior to fermentation. In another embodiment of the present invention, product ω-hydroxyfatty acids or their esters (e.g. methyl esters) and ω-carboxyfatty acids or their esters are partially or completely hydrogenated prior to their use as monomers to prepare polyesters.

A preferred embodiment of the present invention is a process which comprises selecting the one or more diacids or an ester thereof from ω-carboxyllauric acid (ω-COOH-LA), ω-carboxymyristic acid (ω-COOH-MA), ω-carboxypalmitic acid (ω-COOH-PA), ω-carboxypalmitoleic acid (ω-COOH-POA), ω-carboxystearic acid (ω-COOH-SA), ω-carboxyoleic acid (ω-COOH-OA), ω-carboxyricinoleic acid (ω-COOH-RA), ω-carboxyllinoleic acid (ω-COOH-LA), ω-carboxy-α-linolenic acid (ω-COOH-ALA), ω-carboxy-γ-linolenic acid (ω-COOH-GLA), ω-carboxybehenic acid (ω-COOH-BA), ω-carboxyerucic acid (ω-COOH-EA) or a mixture thereof.

Another preferred embodiment of the present invention is a process which comprises selecting one or more diols that are prepared by reduction of diacids or an ester thereof from ω-carboxyllauric acid (ω-COOH-LA), ω-carboxymyristic acid (ω-COOH-MA), ω-carboxypalmitic acid (ω-COOH-PA), ω-carboxypalmitoleic acid (ω-COOH-POA), ω-carboxystearic acid (ω-COOH-SA), ω-carboxyoleic acid (ω-COOH-OA), ω-carboxyricinoleic acid (ω-COOH-RA), ω-carboxyllinoleic acid (ω-COOH-LA), ω-carboxy-α-linolenic acid (ω-COOH-ALA), ω-carboxy-linolenic acid (ω-COOH-GLA), ω-carboxybehenic acid (ω-COOH-BA), ω-carboxyerucic acid (ω-COOH-EA) or a mixture thereof.

Another preferred embodiment of the present invention is a process which comprises selecting one or more diols from ethylene glycol, 1,3-propanediol, 1,4-butanediol, 1,6-hexanediol, 1,8-octanediol, 1,1 O-decanediol, 1,12-dodecanediol, 1,14-tetradecanediol, 1,16-hexadecanediol, 2,2,4,4-tetramethyl-1,3-cyclobutanediol, 4,8-bis(hydroxymethyl)tricyclo[S.2.1.0/2.6]decane, 1,4-cyclohexanedimethanol, die ethylene glycol), tri(ethylene glycol), a poly(ethylene oxide)glycol, a poly(butylene ether) glycol, and isosorbide, or a mixture thereof.

Yet another preferred embodiment of the present invention is a process which comprises selecting the one or more diacids or an ester thereof and including it as a component of the monomer mixture to be polymerized. Diacids or an ester thereof can be selected from the group consisting of oxalic acid, dimethyl oxalate, malonic acid, dimethyl malonate, succinic acid, dimethyl succinate, methyl succinic acid, itaconic, dimethly itaconic acid, maleic acid, dimethyl maleic acid, fumaric acid, dimethly fumaric acid, glutaric acid, dimethyl glutarate, 2-methyl glutaric acid, 3-methylglutaric acid, adipic acid, dimethyl adipate, 3-methyladipic acid, 2,2,5,5-tetramethylhexanedioic acid, pimelic acid, suberic acid, azelaic acid, dimethyl azelate, sebacic acid, 1,11-undecanedicarboxylic acid, 1,1 O-decanedicarboxylic acid, undecanedioic acid, 1,12-dodecanedicarboxylic acid, hexadecanedioic acid, docosanedioic acid, tetracosanedioic acid, dimer acid, 1,4-cyclohexanedicarboxylicacid, dimethyl-1,4-cyclohexanedicarboxylate, 1,3-cyclohexanedicarboxylic acid, dimethyl-1,3-cyclohexanedicarboxylate, 1,1-cyclohexanediacetic acid, 2,S-norbornanedicarboxylic, and mixtures of two or more thereof.

Still another preferred embodiment of the present invention is a process which comprises selecting the one or more diacids or an ester thereof and including it as a component of the monomer mixture to be polymerized. Diacids or an ester thereof can be selected from the group consisting of terephthalic acid, dimethyl terephthalate, isophthalic acid, dimethylisophthalate, 2,6-napthalene dicarboxylic acid, dimethyl-2,6-naphthalate, 2,7-naphthalenedicarboxylic acid, dimethyl-2,7-naphthalate, 3,4′-diphenyl ether dicarboxylic acid, dimethyl-3,4′diphenyl ether dicarboxylate, 4,4′-diphenyl ether dicarboxylic acid, dimethyl-4,4′-diphenyl ether dicarboxylate, 3,4′-diphenyl sulfide dicarboxylic acid, dimethyl-3,4′-diphenyl sulfide dicarboxylate, 4,4′diphenyl sulfide dicarboxylic acid, dimethyl-4,4′-diphenyl sulfide dicarboxylate, 3,4′-diphenyl sulfone dicarboxylic acid, dimethyl-3,4′-diphenyl sulfone dicarboxylate, 4,4′-diphenyl sulfone dicarboxylic acid, dimethyIA,4′-diphenyl sulfone dicarboxylate, 3,4′-benzophenonedicarboxylic acid, dimethyl-3,4′-benzophenonedicarboxylate, 4,4′-benzophenonedicarboxylic acid, dimethyl-4,4′-benzophenonedicarboxylate, 1,4-naphthalene dicarboxylic acid, dimethyl-1,4-naphthalate, 4,4′-methylene bis(benzoic acid) and dimethyl-4,4′-methylenebis(benzoate), or a mixture thereof.

Another embodiment of the present invention is a process which comprises selecting one or more α-hydroxyfatty acids or an ester thereof and including it as a component of the monomer mixture to be polymerized. A more preferred embodiment of the present invention is a process wherein the α-hydroxyfatty acid is selected from α-hydroxylauric acid (α-OH-LA), α-hydroxymyristic acid (α-OH-MA), α-hydroxypalmitic acid (α-OH-PA), α-hydroxy palmitoleic acid (α-OH-POA), α-hydroxy stearic acid (α-OH-SA), α-hydroxyoleic acid (α-OH-OA), α-hydroxyricinoleic acid (α-OH-RA), α-hydroxylinoleic acid (α-OH-LA), α-hydroxy-α-linolenic acid, (α-OH-ALA), α-hydroxy-γ-linolenic acid (α-OH-GLA), α-hydroxybehenic acid (α-OHBA) and α-hydroxyerucic acid (α-OH-EA).

One embodiment of the present invention is a copolyester formed by a process of the present invention comprising an aliphatic or aliphatic/aromatic copolyester comprising one or more ω-hydroxyfatty acids produced by fermentation of a feedstock using an engineered yeast strain, one or more diacids, one or more diols in a molar amount equal to the one or more diacids, and optionally an additive that is a member selected from the group consisting of a branching agent, an ion-containing monomer, and a filler. In another embodiment additional ω-hydroxyacids other than those derived from fermentation of yeast are used in the process of copolyester formation of the present invention.

In one embodiment of the present invention the branching agent is selected from glycerol, pentaerythritol, trimellitic anhydride, pyromellitic dianhydride, tartaric acid, 1,2,4-benzenetricarboxylic acid, (trimellitic acid), trimethyl-1,2,4-benzenetricarboxylate, 1,2,4-benzenetricarboxylic anhydride, (trimellitic anhydride), 1,3,5-benzenetricarboxylic acid, 1,2,4,5-benzenetetracarboxylic acid, (pyromellitic acid), 1,2,4,5-benzenetetracarboxylic dianhydride, (pyromellitic anhydride), 3,3′,4,4′-benzophenonetetracarboxylic dianhydride, 1,4,5,8-naphthalenetetracarboxylic dianhydride, citric acid, tetrahydrofuran-2,3,4,5-tetracarboxylic acid, 1,3,5-cyclohexanetricarboxylic acid, pentaerythritol, glycerol, 2-(hydroxymethyl)-1,3-propanediol, trimethylol propane, 2,2-bis(hydroxymethyl)propionic acid, epoxidized soybean oil and castor oil, or a mixture thereof.

In another embodiment of the present invention the filler is selected from calcium carbonate, non-swellable clays, silica, alumina, barium sulfate, sodium carbonate, talc, magnesium sulfate, titanium dioxide, zeolites, aluminum sulfate, diatomaceous earth, magnesium sulfate, magnesium carbonate, barium carbonate, kaolin, mica, carbon, calcium oxide, magnesium oxide, aluminum hydroxide and polymer particles.

Yet another embodiment of the present invention is a reactive extrusion process for preparing a polymer blend which comprises combining one or more copolyesters comprising ω-hydroxyfatty acid repeat units, one or more additional polymers and optionally a catalyst in a reaction vessel, and providing sufficient energy to the combination of the one or more copolyesters comprising ω-hydroxyfatty acid repeat units, the one or more additional polymers and the optional catalyst in order to form a blend wherein the one or more additional polymers are grafted from the one or more copolyesters.

A more preferred embodiment of the present invention is a reactive extrusion process wherein the weight ratio the ω-hydroxyfatty acid copolyester and the second polymer has from 1 to 99% by wt. of the ω-hydroxyfatty acid copolyester.

An even more preferred embodiment of the present invention is a reactive extrusion process wherein the polyester blend involves a process of reactive extrusion that compatibilizes the blend.

Another embodiment of the present invention is a copolyester wherein the copolyester has inherent viscosity suitable for processing by injection molding, film blowing and formation of an article.

Yet another embodiment of the present invention is a film comprising a copolyester of the present invention, a fiber comprising a copolyester of the present invention, a coating comprising a copolyester of the present invention, a molded article comprising a copolyester of the present invention, a foam comprising a copolyester of the present invention.

### DETAILED DESCRIPTION OF THE INVENTION

The biobased ω-hydroxyfatty acids that comprise the polyesters and copolyesters of the present invention are obtained from pure fatty acids, fatty acid mixtures, pure fatty acid ester, mixtures of fatty acid esters, and triglycerides from various sources, using a fermentation process comprising an engineered yeast strain, such as Candida tropicalis. These copolyesters may contain various amounts and types of ω-carboxyfatty acids depending on the engineered yeast strain used for the bioconversion as well as the feedstock(s) used. Mixtures of ω-hydroxy and α-hydroxyfatty acids are also suitable for use in copolyesters prepared as part of this invention.

The biobased ω-hydroxyfatty acids and ω-carboxyfatty acids of the present invention belong to the larger family of ω-oxidized fatty acids and are synthesized by microbial fermentation using an engineered yeast strain, such as the Candida tropicalis strain described in U.S. application Ser. No. 12/436,729, which is incorporated herein by reference in its entirety. Biobased ω-hydroxyfatty acids, α,ω-dicarboxylic acids, and mixtures thereof may be obtained by oxidative conversion of fatty acids to their corresponding ω-hydroxyfatty acids, α,ω-dicarboxylic acids, or a mixture of these products. Conversion is accomplished by culturing fatty acid substrates with a yeast, preferably a strain of Candida and more preferably a strain of Candida tropicalis. Preferred strains include the engineered strain of Candida tropicalis selected from Candida tropicalis strains DP1, DP390, DP415, DP417, DP421, DP423, DP434 and DP436.

The yeast converts fatty acids to ω-hydroxy fatty acids, ω-carboxyfatty acids (α,ω-dicarboxylic acids also known as α,ω-carboxyfatty acids) and mixtures thereof. Fermentations are conducted in liquid media containing pure fatty acids, fatty acid mixtures, pure fatty acid ester, mixtures of fatty acid esters, and triglycerides from various sources. Biological conversion methods for these compounds use readily renewable resources such as fatty acids as starting materials rather than non-renewable petrochemicals, and give the target ω-hydroxyfatty acids and mixtures of ω-hydroxyfatty acids and ω-carboxyfatty acids (α,ω-dicarboxylic acids). For example, ω-hydroxy fatty acids and α,ω-dicarboxylic acids can be produced from inexpensive long-chain fatty acids, which are readily available from renewable agricultural and forest products such as soybean oil, palm oil and corn oil. Moreover, a wide range of ω-hydroxyfatty acids and α,ω-dicarboxylic acids having different carbon length and degree of unsaturation can be prepared because the yeast biocatalyst accepts a wide range of fatty acid substrates.

A number of fatty acids are found in natural biobased materials such as natural oils. These natural oils and other sources may be used as feedstocks for fermentation. The common name, scientific name and sources for these fatty acids are shown in Table 1. The fatty acids in table 1 are provided as examples of natural fatty acids and the present invention is not limited to the fatty acids disclosed in table 1. One skilled in the art is aware that any fatty acid, even a fatty acid having additional functional groups such as double bonds, epoxides or hydroxyl groups, and in particular any fatty acid from either a natural or non-natural source (for example a synthetic fatty acid) can be used as a source of ω-hydroxyfatty acid for the copolyesters of the present invention.

TABLE 1
Examples of fatty acids and the biosources from which they may be obtained.

| Common Name | Carbon Atoms | Double Bonds | Scientific Name | Common Sources |
|---|---|---|---|---|
| lauric acid (LA) | 12 | 0 | dodecanoic acid | coconut oil |
| myristic acid (MA) | 14 | 0 | tetradecanoic acid | palm kernel oil |
| palmitic acid (PA) | 16 | 0 | hexadecanoic acid | palm oil |
| palmitoleic acid (POA) | 16 | 1 | 9-hexadecenoic acid | animal fats |
| stearic acid (SA) | 18 | 0 | octadecanoic acid | animal fats |
| oleic acid (OA) | 18 | 1 | 9-octadecenoic acid | olive oil |
| ricinoleic acid (RA) | 18 | 1 | 12-hydroxy-9-octadecenoic acid | castor oil |
| linoleic acid (LA) | 18 | 2 | 9,12-octadecadienoic acid | grape seed oil |
| α-linolenic acid (ALA) | 18 | 3 | 9,12,15-octadecatrienoic acid | flaxseed (linseed) oil |
| γ-linolenic acid (GLA) | 18 | 3 | 6,9,12-octadecatrienoic acid | borage oil |
| behenic acid (BA) | 22 | 0 | docosanoic acid | rapeseed oil |
| erucic acid (EA) | 22 | 1 | 13-docosenoic acid | rapeseed oil |

Triglycerides and fatty acid esters derived from triglycerides may be used as feedstocks for the fermentation. In the case that triglycerides or fatty acid esters from triglycerides are used as feedstocks, the ω-hydroxyfatty acids produced by fermentation will consist of a mixture of ω-hydroxylated fatty acids that correspond to structures found from the sourced triglyceride. The fatty acids comprising fatty acid feedstocks of the present invention may comprise one or more double bonds. In one embodiment of the present invention the feedstock is partially or completely hydrogenated prior to fermentation. In another embodiment of the present invention, product ω-hydroxyfatty acids or their esters (e.g. methyl esters) and ω-carboxyfatty acids or their esters are partially or completely hydrogenated prior to their use as monomers to prepare polyesters.

The ω-hydroxyfatty acids produced by fermentation may contain up to 75% of ω-carboxyfatty acid, up to 50% of ω-carboxyfatty acid, less than 5% of ω-carboxyfatty acid, less than 3% of ω-carboxyfatty acid, less than 1% of ω-carboxyfatty acid, or no ω-carboxyfatty acid. These combinations of ω-hydroxyfatty acids and ω-carboxyfatty acids produced by fermentation may be used to prepare the copolyesters of the present invention.

In one embodiment of the present invention, the ω-hydroxyfatty acid monomer obtained by microbial fermentation comprises less than 15% ω-carboxyfatty acid, preferably less than 10% ω-carboxyfatty acid, more preferably less than 5% ω-carboxyfatty acid, even more preferably less than 1% ω-carboxyfatty acid, much more preferably less than 0.5% ω-carboxyfatty acid and most preferably less than 0.1% ω-carboxyfatty acid. In yet another embodiment, the ω-hydroxyfatty acid monomer contains no ω-carboxyfatty acid, or an undetectable quantity of ω-carboxyfatty acid.

In another embodiment of the present invention, the ω-hydroxyfatty acid monomer obtained by microbial fermentation also comprises ω-carboxyfatty acid. In this embodiment, the ω-hydroxyfatty acid monomer comprises preferably at least 15% ω-carboxyfatty acid, more preferably at least 20% ω-carboxyfatty acid, even more preferably at least 30% ω-carboxyfatty acid, much more preferably at least 50% ω-carboxyfatty acid and most preferably at least 75% ω-carboxyfatty acid. In yet another embodiment, the ω-hydroxyfatty acid monomer contains more ω-carboxyfatty acid than ω-hydroxyfatty acid.

The copolyesters of the present invention can have a repeat unit sequence described by being block-like, random or degrees between these extremes. They are aliphatic or aliphatic/aromatic copolyesters formed by copolymerization of an ω-hydroxyfatty acid with a diol, a diacid and optionally one or more additives known in the art or described herein. These ω-hydroxyfatty acids (A-B), diols (B-B), and diacids (A-A) condense to form copolyesters with desired properties (where A represents the “acid” functional group and “B” represents the “hydroxy” functional group). The diacid component of the copolyester may be ω-carboxyfatty acids obtained by microbial fermentation, any other diacid obtained from either a natural or synthetic source, or a combination thereof. The ω-hydroxyfatty acid (A-B) component of the copolyester will consist of from 10 to 100% of the copolymer. The remaining 0 to 90% of the monomers will be comprised of a diol (B-B), a diacid (A-A), and optionally any other additive known in the art or described herein. Unless otherwise noted, the percent composition of the polymers and monomers described herein refer to weight percent.

In another embodiment the copolyesters of the present invention comprise one or more hydroxyacids (also denoted A-B), or an ester thereof, obtained from either a natural or synthetic source. The hydroxyacid can be shorter in chain length than α-OH-lactic acid or ω-OH-lactic acid, mayor may not be derived from a bioprocess, and can have the hydroxyl group at various positions relative to the carboxylic acid functionality. A more preferred embodiment of the present invention is a process wherein the hydroxyacid is selected from the group consisting of lactic acid, glycolic acid (hydroxyacetic acid), 3-hydroxypropionic acid, 3-hydroxybutyric acid, 4-hydroxybutyric acid and 6-hydroxyhexanoic acid. Any of the hydroxyacids may be used in the present invention as a hydroxyacid ester, lactone or lactone multimer. Methods for the formation of hydroxyacid esters, lactones and lactone multimers are well known in the art.

In order to achieve a copolyester having a high molecular weight from a mixture of difunctional monomers that include one or more diols (B-B), diacids (A-A) and ω-hydroxyfatty acids (A-B), the stoichiometry of carboxylic acid to hydroxyl groups are equimolar. Those skilled in the art will recognize that the relative amounts of diol and diacid would vary within experimental error even when the monomers are desired as being equimolar. A skilled artisan would also understand that in cases where a monomer is volatile, for example in the case of low molecular weight diols, the quantity of the volatile monomer will be increased in relation to the less volatile monomer. For example, if the diol component is a volatile diol such as butane diol, then a greater molar quantity of butane diol to diacid will be used in the synthesis of that copolyester.

In order to achieve a low molecular weight copolyester, for example in order to obtain a low molecular weight diol pre-polymer for use in the production of thermoplastic polyurethanes, a person skilled in the art would know to employ a molar excess of diol (B-B) monomer in relation to the diacid (A-A) monomer. In addition, low molecular weight copolyesters having reactive terminal functional groups (represented by X) may be obtained by adding molecules having both an acid and a reactive group (A-X), an alcohol and a reactive group (B-X), and preferably both A-X and B-X molecules. A person skilled in the art would know how by controlling the concentration of A-X and B-X molecules relative to the concentration of A-B, AA and B-B monomers one can control the chain length of resulting low molecular weight prepolymers with terminal reactive functional groups X. Examples of reactive groups include, but are not limited to an epoxide, an acrylate, an azide, a terminal alkyne, maleimide, 5-norbornene, a double bond, and a thiol.

The copolyesters of the present invention may comprise a non-fatty acid derived hydroxyfatty acid (A-B) in addition to the ω-hydroxyfatty acid (A-B). In addition, the diacids (A-A) of the present invention may be ω-diacids derived from the fermentation of a fatty acid feedstock, a non-fatty acid derived diacid, or a mixture thereof. Furthermore, the diol can be prepared by reduction of ω-carboxyfatty acid dimethyl esters. The conversion of carboxylic esters to their corresponding hydroxyl group is well known to those skilled in the art. Also, ω-carboxyfatty acids can be prepared, for example, by feeding fatty acids, pure fatty acids, fatty acid mixtures, pure fatty acid ester, mixtures of fatty acid esters, and triglycerides from various sources, using a fermentation process comprising an engineered yeast strain, such as Candida tropicalis Strain H5343 (ATCC No. 20962).

One embodiment of the present invention is a copolyester comprising 50-100% ω-hydroxyfatty acid (A-B), a 0-50% equimolar mixture of a diol (B-B) and a diacid (A-A), and optionally one or more additives known in the art or described herein. Preferably comprising at least 85% ω-hydroxyfatty acid, more preferably at least 90% ω-hydroxyfatty acid, even more preferably at least 95% ω-hydroxyfatty acid and most preferably at least 98% ω-hydroxyfatty acid.

A second embodiment of the present invention is a copolyester comprising 5-50% ω-hydroxyfatty acid (A-B), a 50-95% equimolar mixture of a diol (B-B) and a diacid (A-A), and optionally one or more additives known in the art or described herein. Preferably comprising no more than 45 mole % ω-hydroxyfatty acid, more preferably no more than 40 mole % ω-hydroxyfatty acid, even more preferably no more than 35 mole % ω-hydroxyfatty acid and most preferably no more than 25 mole % ω-hydroxyfatty acid.

Another embodiment of the present invention is a copolyester comprising an α-hydroxyfatty acid in addition an ω-hydroxyfatty acid. Methods to prepare α-hydroxyfatty acids and representative α-hydroxyfatty acid structures are described in International PCT Publication WO 2009/127009 A1, which is incorporated herein by reference in its entirety.

A still further embodiment of the present invention is a copolyester comprising 50-100% of a mixture of ω-hydroxyfatty acid (A-B) and α-hydroxyfatty acid (A-B), a 0-50% equimolar mixture of a diol (B-B) and a diacid (A-A), and optionally one or more additives known in the art or described herein. The copolyester may comprise 75% or more α-hydroxyfatty acid, 50% α-hydroxyfatty acid or less than 25% α-hydroxyfatty acid. Preferably comprising at least 25% α-hydroxyfatty acid, more preferably at least 10% α-hydroxyfatty acid, even more preferably at least 7.5% α-hydroxyfatty acid and most preferably at least 5% α-hydroxyfatty acid.

A second embodiment of the present invention is a copolyester comprising 5-50% of a mixture of ω-hydroxyfatty acid (A-B) and α-hydroxyfatty acid (A-B), a 50-95% of a mixture consisting of a diol (B-B), a diacid (A-A) and optionally one or more additives known in the art or described herein. The copolyester may comprise 45% or more α-hydroxyfatty acid, 30% α-hydroxyfatty acid or less than 15% α-hydroxyfatty acid. Preferably comprising at least 15% α-hydroxyfatty acid, more preferably at least 10% α-hydroxyfatty acid, even more preferably at least 7.5% α-hydroxyfatty acid and most preferably at least 5% α-hydroxyfatty acid.

The ω-hydroxyfatty acid copolyesters of the present invention will generally have an inherent viscosity in the range of about 0.24 and about 2.0 dL/g as measured at 25° C. in a 60/40 parts by weight solution of phenol/tetrachloroethane. Preferably, the ω-hydroxyfatty acid copolyesters of the present invention will generally have an inherent viscosity of about 0.7 to about 2.0 dL/g, more preferably an inherent viscosity of between about 1.0 and about 2.0 dL/g, and even more preferably an inherent viscosity of about 1.10 and about 1.90 dL/g. The ω-hydroxyfatty acid copolyesters of the present invention preferably have an inherent viscosity of greater than 1.0 dL/g, more preferably greater than 1.2 dL/g, even more preferably greater than 1.5 dL/g and most preferably greater than 1.8 dL/g.

The ω-hydroxyfatty acids of the present invention include but are not limited to ω-hydroxyl auric acid (ω-OH-LA), ω-hydroxymyristic acid (ω-OH-MA), ω-hydroxypalmitic acid (ω-OH-PA), ω-hydroxy palmitoleic acid (ω-OH-POA), ω-hydroxystearic acid (ω-OH-SA), ω-hydroxyoleic acid (ω-OH-OA), ω-hydroxyricinoleic acid (ω-OH-RA), ω-hydroxylinoleic Acid (ω-OH-LA), ω-hydroxy-α-linolenic acid, (ω-OH-ALA), ω-hydroxy-γ-linolenic acid (ω-OHGLA), ω-hydroxybehenic acid (ω-OH-BA) and ω-hydroxyerucic acid (ω-OH-EA).

The ω-carboxyfatty acids of the present invention include but are not limited to ω-carboxyllauric acid (ω-COOH-LA), ω-carboxymyristic acid (ω-COOH-MA), ω-carboxypalmitic acid (ω-COOH-PA), ω-carboxypalmitoleic acid (ω-COOH-POA), ω-carboxystearic acid (ω-COOH-SA), ω-carboxyoleic acid (ω-COOH-OA), ω-carboxyricinoleic acid (ω-COOH-RA), ω-carboxyllinoleic acid (ω-COOH-LA), ω-carboxy-a.-linolenic acid (ω-COOH-ALA), ω-carboxy-linolenic acid (ω-COOH-GLA), ω-carboxybehenic acid (ω-COOH-BA) and ω-carboxyerucic acid (ω-COOH-EA).

In one embodiment of the present invention, the ω-carboxyfatty acids are prepared using pure fatty acids, fatty acid mixtures, pure fatty acid ester, mixtures of fatty acid esters, and triglycerides from various sources as feedstocks in a fermentation process comprising an engineered yeast strain, such as Candida tropicalis Strain H5343 (ATCC No. 20962).

Where triglycerides or fatty acid esters from triglycerides arc used as the fermentation feedstock, the ω-hydroxyfatty acids produced by the fermentation will consist of a mixture of ω-hydroxylated fatty acids, or a mixture of ω-hydroxylated and ω-carboxylated fatty acids, that correspond to the fatty acids comprising the sourced triglyceride. In addition, the feedstock may be subjected to chemical manipulation prior to fermentation. For example, a fatty acid feedstock can be subjected to hydrogenolysis, thereby saturating all or some of the double bond containing fatty acids. Alternatively, ω-hydroxyfatty acids or their esters (e.g. methyl esters) and ω-carboxyfatty acids or their esters produced by fermentations may be subjected to chemical manipulation. For example, they can be subjected to hydrogenolysis, thereby saturating all or some of their double bonds. In the case of complete hydrogenolysis of the feedstock prior to fermentation or the products from fermentation, the resulting ω-hydroxyfatty acids or their esters (e.g. methyl esters) and ω-carboxyfatty acids or their esters will be greatly simplified and comprise a mixture of products that differ only in chain length.

The dicarboxylic acids (A-A) of the present invention may be selected from any dicarboxylic acid. Non-limiting examples include unsubstituted or substituted; straight chain, branched, cyclic aliphatic, aliphatic-aromatic, or aromatic diacids having, for example, from 2 to 36 carbon atoms or poly(alkylene ether) diacids with molecular weights preferably between about 250 to about 4,000. Diacids used can be in free acid form or can be used as corresponding esters such as dimethyl ester derivatives. Methods for the formation of carboxylic acid esters are well known in the art.

Specific examples of useful aliphatic diacid components include oxalic acid, dimethyl oxalate, malonic acid, dimethyl malonate, succinic acid, dimethyl succinate, methyl succinic acid, itaconic, dimethly itaconic acid, maleic acid, dimethyl maleic acid, fumaric acid, dimethly fumaric acid, glutaric acid, dimethyl glutarate, 2-methylglutaric acid, 3-methylglutaric acid, adipic acid, dimethyl adipate, 3-methyladipic acid, 2,2,5,5-tetramethylhexanedioic acid, pimelic acid, suberic acid, azelaic acid, dimethyl azelate, sebacic acid, 1,11-undecanedicarboxylic acid, 1,10-decanedicarboxylic acid, undecanedioic acid, 1,12-dodecanedicarboxylic acid, hexadecanedioic acid, docosanedioic acid, tetracosanedioic acid, dimer acid, 1,4-cyclohexanedicarboxylic acid, dimethyl-1,4-cyclohexanedicarboxylate, 1,3-cyclohexanedicarboxylic acid, dimethyl-1,3-cyclohexanedicarboxylate, 1,1-cyclohexanediacetic acid, 2,5-norbornanedicarboxylic, and mixtures of two or more thereof. Specific examples of useful aromatic diacid components include aromatic dicarboxylic acids or esters, and include terephthalic acid, dimethyl terephthalate, isophthalic acid, dimethylisophthalate, 2,6-napthalene dicarboxylic acid, dimethyl-2,6-naphthalate, 2,7-naphthalenedicarboxylic acid, dimethyl-2,7-naphthalate, 3,4′-diphenyl ether dicarboxylic acid, dimethyl-3,4′diphenyl ether dicarboxylate, 4,4′-diphenyl ether dicarboxylic acid, dimethyl-4,4′diphenyl ether dicarboxylate, 3,4′-diphenyl sulfide dicarboxylic acid, dimethyl-3,4′-diphenyl sulfide dicarboxylate, 4,4′-diphenyl sulfide dicarboxylic acid, dimethyl-4,4′-diphenyl sulfide dicarboxylate, 3,4′-diphenyl sulfone dicarboxylicacid, dimethyl-3,4′-diphenyl sulfone dicarboxylate, 4,4′-diphenyl sulfone dicarboxylic acid, dimethyl-4,4′-diphenyl sulfone dicarboxylate, 3,4′-benzophenonedicarboxylic acid, dimethyl-3,4′-benzophcnoncdicarboxylate, 4,4′-benzophenonedicarboxylic acid, dimethyl, 4,4′-benzophenonedicarboxylate, 1,4-naphthalene dicarboxylic acid, dimethyl-1,4-naphthalate, 4,4′-methylene bis(benzoic acid) and dimethyl-4,4′methylenebis(benzoate), or a mixture thereof.

The diol (B-B) of the present invention may be selected from any dihydric alcohol, glycol, or diol. Non-limiting examples include unsubstituted or substituted; straight chain, branched, cyclic aliphatic, aliphatic-aromatic, or aromatic diols having, for example, from 2 to 36 carbon atoms or poly(alkylene ether) diols with molecular weights between about 250 to about 4,000. Specific examples of diols include ethylene glycol, 1,3-propanediol, 1,4-butanediol, 1,6-hexanediol, 1,8-octanediol, 1,1 O-decanediol, 1,12-dodecanediol, 1,14-tetradecanediol, 1,16-hexadecanediol, 2,2,4,4-tetramethyl-1,3-cyclobutanediol, 4,8-bis(hydroxymethyl)tricyclo[5.2.1.0/2.6]decane, 1,4-cyclohexanedimethanol, di(ethylene glycol), tri(ethylene glycol), poly(ethylene oxide)glycols, poly(butylene ether) glycols, and isosorbide, or a mixture thereof.

Diols of the present invention may also be prepared by the reduction of a diacid, including ω-carboxyfatty acid dimethyl esters. Methods for the reduction of carboxylic acids and carboxylic acid esters are well known in the art. Common methods include the use of hydride reducing agents such as lithium aluminum hydride (LAH) and diisobutyl aluminum hydride (DIBAL), among others.

As used herein, the term “alkylene” refers to either straight or branched chain alkyl groups, such as —CH2-CH2-CH2- or —CH2-CH(CH3)-CH2-, and the term “cycloalkylene” refers to cyclic alkylene groups which may or may not be substituted. The term “oxyalkylene” refers to an alkylene group which contains one or more oxygen atoms, such as —CH2-CH2-0-CH2-CH2-, which also may be linear or branched.

As used herein, “glass transition temperature” means that temperature below which a polymer becomes hard and brittle, like glass.

As used herein, the term “precursor film” is meant to include films that have not been stretched or otherwise physically manipulated prior to use and/or evaluation and analysis. This includes films that contain a filler material, such as calcium carbonate, that have not been stretched to create the pores around the calcium carbonate to allow water vapor to pass through the film.

As used herein, the term “stretched film” is meant to include films that have been stretched to create pores around a filler material. These stretched films are ready for use in an absorbent article as they will allow water vapor to pass through.

Methods of preparing aliphatic and aromatic-aliphatic copolyesters are known in the art. Most commonly, a mixture of monomers that includes a dicarboxylic acid (designated A-A), and a diol (designated B-B) are reacted in the presence of a catalyst. Water is driven off, and under proper conditions, a copolyester results that can have a repeat unit sequence described by being block-like, random or degrees between these extremes. Alternative synthetic methods include using methyl esters in place of the carboxylic acids. In these methods methanol is volatilized rather than water during the reaction. Other synthesis methods are also known to those skilled in the art. Typically, reactions are carried out using diols and diacids (or diesters or anhydrides) at temperatures from about 150° C. to about 300° c. in the presence of polycondensation catalysts such as titanium tetrachloride, manganese diacetate, antimony oxide, dibutyl tin diacetate, zinc chloride, or combinations thereof.

One embodiment of the present invention is a process for the preparation of an aliphatic or aliphatic/aromatic copolyester comprising one or more ω-hydroxyfatty acids, or an ester thereof, and one or more ω-carboxyfatty acids, or an ester thereof, obtained by fermentation of a feedstock using an engineered strain of yeast. The process involves adding a diol in a molar amount equal to the molar amount of the ω-carboxyfatty acid components and heating the mixture in the presence of a catalyst or catalyst mixture to between about 180° C. to about 300 DC. The catalyst can either be included initially in the reactant mixture, or can be added one or more times while the mixture is heated. Desirably the polymerization is performed in two stages. In a first stage, said reaction mixture is heated between 180° C. and 220° c. at or slightly above atmospheric pressure, and in a second stage, heating said reaction mixture between 180° C. and 260° C. under a reduced pressure of 0.05 to 2.00 mm of Hg. The conditions and the catalysts depend in part upon whether the diacids are polymerized as true acids or as dimethyl esters. The heating and stirring are continued for a sufficient time and to a sufficient temperature, generally with removal of excess reactants under vacuum, to yield a molten polymer having a high enough molecular weight to be suitable for making fabricated products.

A suitable catalyst is selected from salts of Li, Ca, Mg, Mn, Zn, Pb, Sb, Sn, Ge, and Ti, such as acetate salts and oxides, including glycol adducts, and Ti alkoxides. Such catalysts are known, and a catalyst or combination or sequence of catalysts used can be selected by a skilled practitioner. The preferred catalyst and preferred conditions can vary depending upon, for example, whether the diacid monomer is polymerized as the free diacid or as a dimethyl ester, and/or on the chemical composition of the diol, hydroxyfatty acid and diacid components. The catalyst used can be modified as the reaction proceeds. Any catalyst system known for use in such polymerizations can be used.

Titanium-based catalyst systems (e.g. titanium tetraisopropoxide, titanium tetraethoxide, titanium tetrabutoxide, titanium tetrachloride) are commonly used in the presence of a phosphorus-based additive. Catalyst concentrations generally range from 10 to 1000 ppm. Furthermore, reactions are best carried out in two stages as described herein. The final stages of the reaction are generally conducted under high vacuum <<10 mm of Hg) in order to produce a high molecular weight polyester.

It is preferable not to have a solvent present in the reactant vessel for the condensation and ring-opening polymerization reactions of the present invention. However, a solvent may be necessary when synthesizing polymers of high viscosity or when using monomers, and forming polymers, with melting points above 100° C. When a solvent is used, preferred organic solvents are those not containing a hydroxyl group, including but not limited to tetrahydrofuran, toluene, diethyl ether, diphenyl ether, diisopropyl ether, dioxane, isooctane, do de cane, methylene chloride and chloroform. The range of solvent used is from 0.0% to 90% by weight relative to the monomer. Although a solvent is not necessary, using an amount of solvent approximately twice the volume of the monomer has been found to provide satisfactory results.

Condensation polymerizations of diacids and diols may also be performed using enzyme catalysis with enzymes such as lipase. Mahapatro et al., 2004, Macromolecules 37, 35-40, describes catalysis of condensation polymerizations between adipic acid and 1,8-octanediol using immobilized Lipase B from Candida antarctica (CALB) as the catalyst. Effects of substrates and solvents on lipase-catalyzed condensation polymerizations of diacids and diols have been also described. See Olsson, et al., Biomacromolecules, 2003, 4: 544-551. U.S. Pat. No. 6,486,295, which is incorporated by reference herein in its entirety, describes the formation of copolymers using lipase catalyzed transesterification reactions of preformed polymers and monomers.

Lipase-catalyzed polymerization of monomers containing functional groups including alkenes and epoxy groups to prepare polyesters has also been disclosed. Warwel et al. report polymerization via transesterification reactions of long-chain unsaturated or epoxidized α,ω-dicarboxylic acid diesters (C18, C20 and C26 α,ω-dicarboxylic acid methyl esters) with diols using Novozym 435 as catalyst. See Warwel, 1995, et al. J. Mol. Catal. B: Enzymatic. 1, 29-35, which is hereby incorporated by reference in its entirety. The α,ω-dicarboxylic acid methyl esters were synthesized by metathetical dimerization of 9-decenoic, 10-undecenioc and 13-tetradecenioc acid methyl esters, and polycondensation with 1,4-butanediol in diphenyl ether yielded the polyesters with molecular weight (Mw) of 7800-9900 g/mol. Uyama et al. report polymerization of epoxidized fatty acids (in side-chain) with divinyl sebacate and glycerol to prepare epoxide-containing polyesters in good yields. See Uyama, et al., 2003, Biomacromolecules 4, 211-215, which is hereby incorporated by reference in its entirety. In Biomacromolecules 8, 757-760 (2007), cis-9,10-epoxy-18-hydroxyoctadecanoic acid, isolated from suberin in the outer bark of birch, was used as a monomer in the synthesis an epoxyfuctionalized polyester using Novozym 435 as catalyst.

The preferred lipases of the present invention include Candida antartica Lipase B, PS-30, immobilized form of Candida antartica lipase B such as Novozym 435, immobilized lipase PS from Pseudomonas fluorescens, immobilized lipase PC from Pseudomonas cepacia, lipase PA from Pseudomonas aeruginosa, lipase from Porcine Pancreas (PPL), Candida cylindreacea (CCL), Candida rugosa (CR), Penicillium roquelorti (PR), Aspergillus niger (AK), and Lypozyme 1M from Mucor miehei. Also, cutinases can be used as catalysts. Preferably, the cutinase from Humicola insolens immobilized on a macroporous resin is useful for catalysis of polyester synthesis. Preferably, between 0.0001% to 20% by weight of the immobilized enzyme catalyst is used, and more preferably approximately 10% immobilized enzyme catalyst, that has between 0.0001% to 2% protein, and more preferably approximately 1% protein, provides satisfactory results.

It is preferable not to have a solvent present in the reactant vessel for lipase catalyzed polymerizations. However, a solvent may be necessary when synthesizing polymers of high viscosity or when using monomers, and forming polymers, with melting points above 100° C. When a solvent is used, preferred organic solvents are those not containing a hydroxyl group, including but not limited to tetrahydrofuran, toluene, diethyl ether, diphenyl ether, diisopropylether and isooctane. The range of solvent used is from 0.0% to 90% by weight relative to the monomer. Although a solvent is not necessary, using an amount of solvent approximately twice the volume of the monomer has been found to provide satisfactory results.

The copolyesters of the present invention may also be formed by ring-opening polymerization of the corresponding lactone or a macro lactone multimer of the ω-hydroxyfatty acids. The macro lactone multimer may comprise two or more ω-hydroxyfatty acids. Ring opening polymerization is a polymerization process in which polymerization proceeds as a result of ring-opening of a cyclic compound as a monomer to synthetically yield a polymer. Industrially important synthetic polymers such as nylons (polyamides), polyethers, polyethyleneimines, polysiloxanes and polyesters, are produced through ring-opening polymerization. Ring-opening polymerization has been applied to synthesize a number of polyesters, such as polylactides and polycaprolactones. For example, ring-opening polymerization of ε-caprolactone using heat and a catalyst such as stannous octanoate provides the polyester polycaprolactone. Polylactic acid is obtained first through bacterial fermentation to produce lactic acid, then lactic acid is catalytically converted to lactide, a cyclic dimer, which is used as a monomer for polymerization. Polylactic acid of high molecular weight is produced by ring-opening polymerization using a stannous octanoate catalyst in most industrial applications, however tin(II) chloride has also employed.

The copolyesters of the present invention may be formed by ring-opening polymerization by first cyclizing the ω-hydroxyfatty acids to their corresponding lactones or macro lactone multimers. Methods for the formation of lactones and macro lactone multimers are well known in the art.

Ring-opening polymerization of lactones and the ω-hydroxyfatty acid lactones of the present invention may be catalyzed by any number of catalysts, including antimony compounds, such as antimony trioxide or antimony trihalides, zinc compounds (zinc lactate) and tin compounds like stannous octanoate (tin(II) 2-ethylhexanoate), tin(II) chloride or tin alkoxides. Stannous octanoate is the most commonly used initiator, since it is approved by the U.S. Food and Drug Administration (FDA) as a food stabilizer. The use of other catalysts such as aluminum isopropoxide, calcium acetylacetonate, and several lanthanide alkoxides (e.g. yttrium isopropoxide) has also been described (See, for example, U.S. Pat. No. 2,668,162 entitled “Preparation of high molecular weight polyhydroxyacetic ester”, which is herein incorporated by reference in its entirety; Bero, Maciej; Piotr Dobrzynski, Janusz Kasperczyk, “Application of Calcium Acetylacetonate to the Polymerization of Glycolide and Copolymerization of Glycolide with e-Caprolactone and L-Lactide,” Macromolecules, 1999, 32, 4735-4737; Stridsberg, Kajsa M.; Maria Ryner, Ann-Christine Albertsson, “Controlled Ring-Opening Polymerization: Polymers with designed Macromolecular Architecture,” Advances in Polymer Science, 2002, 157, 41-65). U.S. Pat. No. 7,622,547 entitled “Process and Activated Carbon Catalyst for Ring-Opening Polymerization of Lactone Compounds,” which is incorporated herein by reference in its entirety, describes the ring-opening polymerization of lactones to polylactones using an activated carbon catalyst in the presence of an alcoholic initiator.

The ω-hydroxyfatty acid lactones of the present invention may be copolymerized using ring-opening polymerization in the presence of one or more additional lactones. Additional lactones useful in the present invention include α-hydroxyfatty acid lactones or macro lactone multimers, β-propiolactone, β-butyrolactone, β-valerolactone, γ-butyrolactone, γ-valerolactone, γ-caprylolactone, δ-valerolactone, β-methyl-δ-valerolactone, δ-stearolactone, ε-caprolactone, 2-methyl-ε-caprolactone, 4-methyl-ε-caprolactone, ε-caprylolactone, and ε-palmitolactone. In this connection, cyclic dimers such as glycolides and lactides can also be used as monomers in ring opening polymerization, as with lactones. Likewise, cyclic carbonate compounds such as ethylene carbonate, 1,3-propylene carbonate, neopentyl carbonate, 2-methyl-1,3-propylene carbonate, and 1,4-butanediol carbonate can be used herein.

The copolyesters of the present invention have variable biobased content and biodegradability that depends on the monomer compositions used. U.S. Pat. No. 7,153,569, entitled, “Biodegradable aliphatic-aromatic copolyester films,” which is incorporated herein by reference in its entirety, discloses that aliphatic-aromatic copolyester films are biodegradable. For example, when the biodegradable aliphatic-aromatic copolyester comprises from about 15 mole % to about 25 mole % of aromatic dicarboxylic acid or an ester thereof, from about 25 mole % to about 35% mole % of aliphatic dicarboxylic acid or an ester thereof, and from about 40 mole % to about 60 mole % dihydric alcohol and wherein the weight average molecular weight of the copolyester is from about 100,000 to about 130,000 Daltons, and wherein the number average molecular weight of the copolyester is from about 40,000 to about 60,000 Daltons.

Variation in monomer composition of the copolyesters of the present invention will result in copolymers suitable for injection molding, film blowing and other common melt processing methods. Melting temperatures of linear aliphatic polyesters below 80° C.-90° c. are generally not useful for most commercial applications due to dimensional instability upon storage in warm environments. Two known aliphatic polyesters which have unusually high melting temperatures are poly(tetramethylene succinate) and poly(ethylene succinate), which are 120° C. and 104° C., respectively. The melting temperatures of the ω-hydroxyfatty acid copolyesters of the present invention range from about 80° C. to about 180° C. Preferably, the ω-hydroxyfatty acid copolyesters of the present invention have a melting temperature from about 90° C. to about 150° c. The ω-hydroxyfatty acid copolyesters of the present invention preferably have a melting temperature greater than 100° C., more preferably greater than 140° C., even more preferably greater than 110° c. and most preferably greater than 120° C.

The monomer composition of the polymer can be selected for specific uses and for specific sets of properties. For example, one skilled in the art knows that thermal properties of a copolyester are determined by the chemical identity and level of each component utilized in the copolyester composition. Inherent viscosity is another property of the copolyester known to one of skill in the art to vary based on copolyester composition. Inherent viscosity is a viscometric method for measuring molecular size. Inherent viscosity is based on the flow time of a polymer solution through a narrow capillary relative to the flow time of the pure solvent through the capillary. The units of inherent viscosity are typically reported in deciliters per gram (dL/g). Copolyesters having adequate inherent viscosity for many applications can be made by the processes disclosed herein and by those methods known to one skilled in the art.

Melt condensation can be used to obtain copolymers of adequate inherent viscosity. Solid state polymerization can be used to obtain even higher inherent viscosities (molecular weights). Copolyesters made by melt polymerization, after extruding, cooling and pelletizing, may be semi crystalline or essentially noncrystalline. Noncrystalline material can be made semicrystalline by heating it to a temperature above the glass transition temperature for an extended period of time. This induces crystallization so that the product can then be heated to a higher temperature to raise the molecular weight. If desired, the polymer can be crystallized prior to solid-state polymerization by treatment with a relatively poor solvent for polyesters, which induces crystallization by reducing the T g. Solvent induced crystallization is known for polyesters and is disclosed, for example, in U.S. Pat. Nos. 5,164,478 and 3,684,766, which are incorporated herein by reference in their entireties.

The semicrystalline polymer can then be subjected to solid state polymerization by placing the pelletized or pulverized polymer into a stream of an inert gas, usually nitrogen, or under a vacuum of 1 Torr, at an elevated temperature, but below the melting temperature of the polymer for an extended period of time until the desired molecular weight is achieved.

It is preferred that the copolyesters of this invention are essentially linear. However, these copolyesters can be modified with low levels of one or more branching agents. A branching agent is a molecule that has at least three functional groups that can participate in a polyester-forming reaction, such as hydroxyl, carboxylic acid, carboxylic ester, phosphorous based ester (potentially trifunctional) and anhydride (difunctional). Typical branching agents useful in the present invention include glycerol, pentaerythritol, trimellitic anhydride, pyromellitic dianhydride, tartaric acid (and derivatives thereof), 1,2,4-benzenetricarboxylic acid, (trimellitic acid), trimethyl-1,2,4-benzenetricarboxylate, 1,2,4-benzenetricarboxylic anhydride, (trimellitic anhydride), 1,3,5-benzenetricarboxylic acid, 1,2,4,5-benzenetetracarboxylic acid, (pyromellitic acid), 1,2,4,5-benzenetetracarboxylic dianhydride, (pyromellitic anhydride), 3,3′,4,4′-benzophenonetetracarboxylic dianhydride, 1,4,5,8-naphthalenetetracarboxylic dianhydride, citric acid, tetrahydrofuran-2,3,4,5-tetracarboxylic acid, 1,3,5-cyclohexanetricarboxylic acid, pentaerythritol, glycerol, 2-(hydroxymethyl)-1,3-propanediol, trimethylol propane, 2,2-bis(hydroxymethyl)propionic acid, epoxidized soybean oil and castor oil, or a mixture thereof. The use of a polyfunctional branching agent may be desirable when higher resin melt viscosity is desired for specific end uses. Examples of such end uses include melt extrusion coatings, melt blown films or containers, and foam.

The total amount of branching agent may be less than about 10% by weight of the total polymer. Alternatively, the branching agent may be less than about 5%, or less than about 3%. A preferred range for branching agents in the present invention is from about 0.1 to about 2.0 weight %, more preferably about 0.2 to about 1.0 weight %, based on the total weight of the polyester. Addition of branching agents at low levels does not have a significant detrimental effect on the physical properties and provides additional melt strength which can be very useful in film extruding operations. High levels of branching agents incorporated in the copolyesters can result in copolyesters with poor physical properties (e.g., low elongation and low biodegradation rates).

Additional examples of compounds that can be used as additives for the copolyesters of this invention include phosphites such as those described in U.S. Pat. No. 4,097,431 entitled “Aromatic Copolyester Composition,” which is incorporated by reference herein in its entirety. Exemplary phosphites include, but are not limited to, tris-(2,4-di-t-butylphenyl)phosphite; tetrakis-(2,4-di-t-butylphenyl)-4,4′-biphenylene phosphite; bis-(2,4-di-tbutylphenyl)pentaerythritol diphosphite; bis-(2,6-di-t-butyl-4-methylphenyl)pentaerythritol diphosphite; 2,2-methylenebis-(4,6-di-t-butylphenyl)octylphosphite; 4,4-butylidenebis-(3-methyl-6-t-butylphenyl-di-tridecyl)phosphite; 1,1,3-tris-(2-methyl-4-tridecylphosphite-5-t-butylphenyl)butane; tris-(mixed mono- and nonylphenyl)phosphite; tris-(nonylphenyl)phosphite; and 4,4′-isopropylidene bis-(phenyl-dialkylphosphite). Preferred compounds are tris-(2,4-di-tbutylphenyl)phosphite; 2,2-methylenebis-(4,6-bi-t-butylphenyl)octylphosphite; bis-(2,6-di-tbutyl-4-methylphenyl)pentaerythritol diphosphite, and tetrakis-(2,4-di-t-butylphenyl)-4,4′biphenylenephosphonite.

In this invention, it is possible to use one of a combination of more than one type of phosphite or phosphonite compound. The total level for the presence of each or both of the phosphite and phosphonite is in the range of about 0.05-2.0 weight %, preferably 0.1-1.0 weight %, and more preferably 0.1-0.5 weight %.

It is possible to use either one such phosphite or phosphonite or a combination of two or more, as long as the total concentration is in the range of 0.05-2.0 weight %, preferably 0.1-1.0 weight %, and more preferably, 0.1-0.5 weight %.

Particularly preferred phosphites include Weston stabilizers such as Weston 619, a product of General Electric Specialty Chemicals Company, distearyl pentaerythritol diphosphite, Ultranox stabilizers such as Ultranox 626, an aromatic phosphite produced by General Electric Specialty Chemicals Company, bis(2,4-di-t-butylphenyl)pentaerythritol diphosphite, and Irgafos 168, an aromatic phosphite produced by Ciba-Geigy Corp. Another example of an aromatic phosphite compound useful within the context of this invention is Ultranox 633, a General Electric Specialty Chemical Company developmental compound.

The copolyesters of the present invention may be prepared by including one or more ion-containing monomers in the monomer mixture to be polymerized. The ion-containing monomer may be, for example, an alkaline earth metal salt of a sulfonate group. Copolyesters containing sulfonate groups are sulfonated copolyesters. The sulfonated copolyesters contain from 0.1 to 5 mole percent of sulfonate groups. While it is not intended that the present invention be bound by any particular theory, it is believed that the presence of the sulfonate groups enhances the biodegradation rates of the copolyesters. The sulfonate groups can be introduced in aliphatic or aromatic monomers or can be introduced as end groups. Exemplary aliphatic sulfonate components include metal salts of sulfosuccinic acid. Exemplary aromatic sulfonate components useful as end-groups include metal salts of 3-sulfobenzoic acid, 4-sulfobenzoic acid, and 5-sulfosalicylic acid. Sulfonate components may contain a sulfonate salt group attached to an aromatic dicarboxylic acid. Aromatic nuclei that can be present in the aromatic dicaraboxylic acid include benzene, naphthalene, diphenyl, oxydiphenyl, sulfonyldiphenyl, methylenediphenyl. The sulfonate component can be the residue of a sulfonate-substituted phthalic acid, terephthalic acid, isophthalic acid, or 2,6-naphthalenedicarboxylic acid. The sulfonate component can be the metal salt of 5-sulfoisophthalic acid or a lower alkyl ester of 5-sulfoisophthalate. The metal salt can be selected from monovalent or polyvalent alkali metal ions, alkaline earth metal ions, or other metal ions. Preferred alkali metal ions include sodium, potassium and lithium. However, alkaline earth metals such as magnesium are also useful. Other useful metal ions include the transition metal ions, such as zinc, cobalt or iron. The multivalent metal ions are useful, for example, when an increased viscosity of the sulfonated copolyesters are desired. End use examples where such melt viscosity enhancements may prove useful include melt extrusion coatings, melt blown containers or film, and foam. As little as 0.1 mole percent of the sulfonate group contributes significantly to the property characteristics of the resultant films or coatings. More preferably, the amount of sulfonate group-containing component in the sulfonated aliphatic-aromatic copolyester is 0.1 to 4.0 mole percent.

The copolyesters of the present invention may be blended with other polymeric materials, which may be biodegradable or non-biodegradable, and may be naturally derived, modified naturally derived or synthetic. Examples of blendable biodegradable materials include poly(vinyl alcohol), polyethylene glycols, sulfonated aliphatic-aromatic copolyesters, such as those sold under the Biomax® trade name by the DuPont Company, aliphatic-aromatic copolyesters, such as are sold under the Eastar Bio® trade name by the Eastman Chemical Company, those sold under the Ecoflex® trade name by the BASF corporation, and those sold under the EnPol® trade name by the Ire Chemical Company; aliphatic polyesters, such as the poly(alkylene succinates), poly(1,4-butylene succinate) (Bionolle® 1001, from Showa High Polymer Company), poly(ethylene succinate), poly(I,4-butylene adipate-ω-succinate) (Bionolle® 3001, from the Showa High Polymer Company), and poly(1,4-butylene adipate) as, for example, sold by the Ire Chemical Company under the trade name of EnPol®, sold by the Showa High Polymer Company under the trade name of Bionolle®, sold by the Mitsui Toatsu Company, sold by the Nippon Shokubai Company, sold by the Cheil Synthetics Company, sold by the Eastman Chemical Company, and sold by the Sunkyon Industries Company, poly(amide esters), for example, as sold under the Bak® trade name by the Bayer Company (these materials are believed to include the constituents of adipic acid, 1,4-butanediol, and 6-aminocaproic acid), polycarbonates, for example such as poly(ethylene carbonate) sold by the PAC Polymers Company, poly(hydroxyalkanoates), such as poly(hydroxybutyrate), poly(hydroxyvalerate), poly(hydroxybutyrate-ω-hydroxyvalerate), poly(lactide-ω-glycolide-ω-ε-caprolactone), for example as sold by the Mitsui Chemicals Company under the grade designations of Hl00J, Sl00, and T100, poly(ε-caprolactone), for example as sold under the Tone® trade name by the Union Carbide Company and as sold by the Daicel Chemical Company and the Solvay Company, and poly(lactide), for example as sold by the Cargill Dow Company under the trade name of EcoPLA® and the Dianippon Company, and mixtures derived therefrom.

Examples of blendable nonbiodegradable polymeric materials include polyethylene, high density polyethylene, low density polyethylene, linear low density polyethylene, ultra low density polyethylene, polyolefins, poly(ethylene-co-glycidylmethacrylate), poly(ethylene-co-methyl methacrylate-co-glycidyl acrylate), poly(ethylene-co-n-butyl acrylate-co-glycidyl acrylate), poly(ethylene-co-methyl acrylate), poly(ethylene-co-ethyl acrylate), poly(ethylene-co-butyl acrylate), poly(ethylene-co-methacrylie acid), metal salts of poly(ethylene-co-methacrylic acid), poly(methacrylates), such as poly(methyl methacrylate), poly(ethyl methacrylate), poly(ethylene-co-carbon monoxide), poly(vinyl acetate), poly(ethylene-co-vinyl acetate), poly(ethylene-co-vinyl alcohol), polypropylene, polybutylene, poly(ethylene terephthalate), poly(1,3-propyl terephthalate), poly(1,4-butylene terephthalate), poly(ethylene-co-1,4-cyclohexanedimethanol terephthalate), poly(vinyl chloride), poly(vinylidene chloride), polystyrene, syndiotactic polystyrene, poly(4-hydroxystyrene), novalacs, poly(cresols), polyamides, nylon 6, nylon 46, nylon 66, nylon 612, polycarbonates, poly(bisphenol A carbonate), polysulfides, poly(phenylene sulfide), polyethers, poly(2,6-dimethylphenylene oxide), polysulfones, and copolymers thereof and mixtures derived therefrom.

Examples of blendable natural or modified natural polymeric materials include starch, starch derivatives, modified starch, thermoplastic starch, cationic starch, anionic starch, starch esters (e.g. starch acetate), starch hydroxyethyl ether, alkyl starches, dextrins, amine starches, phosphate starches, dialdehyde starches, cellulose, cellulose derivatives, modified cellulose, cellulose acetate, cellulose diacetate, cellulose propionate, cellulose butyrate, cellulose valerate, cellulose triacetate, cellulose tripropionate, cellulose tributyrate, and cellulose mixed esters such as cellulose acetate propionate and cellulose acetate butyrate, cellulose ethers, such as methylhydroxyethylcellulose, hydroxymethylethylcellulose, carboxymethylcellulose, methyl cellulose, ethylcellulose, hydroxyethycellulose, and hydroxyethylpropylcellulose, polysaccharides, alginic acid, alginates, phycocolloids, agar, gum arabic, guar gum, acacia gum, carrageenan gum, furcellaran gum, ghafti gum, psyllium gum, quince gum, tamarind gum, locust bean gum, gum karaya, xanthan gum, gum tragacanth, proteins, Zein® prolamine derived from corn, collagen, derivatives thereof such as gelatin and glue, casein, sunflower protein, egg protein, soybean protein, vegetable gelatins, gluten, and mixtures derived therefrom. Thermoplastic starch can be produced, for example, as in U.S. Pat. No. 5,362,777, which discloses the mixing and heating of native or modified starch with high boiling plasticizers, such as glycerin or sorbitol, in such a way that the starch has little or no crystallinity, a low glass transition temperature and a low water content. This patent is incorporated by reference herein in its entirety.

The polymeric material to be blended with the copolyester of the present invention can be added to the copolyester at any stage during the polymerization or after the polymerization is completed. For example, the polymeric materials may be added with the copolyester monomers at the start of the polymerization process. Alternatively, the polymeric material can be added at an intermediate stage of the polymerization, for example, as the precondensate passes into the polymerization vessel. As yet a further alternative, the polymeric material can be added after the copolyester exits the polymerization reactor. For example, the copolyester and the polymeric material can be melt fed to any intensive mixing operation, such as a static mixer or a single- or twin-screw extruder and thereby compounded with the copolyester.

In an alternative method to produce blends of the copolyesters and another polymeric material, the copolyester can be combined with the polymeric material in a subsequent postpolymerization process. Typically, such a process includes intensive mixing of the molten copolyester with the polymeric material, which may be provided through static mixers, Brabender mixers, single screw extruders, twin screw extruders as described hereinabove with regard to the incorporation of fillers.

The copolyesters of the present invention may be blended with other polymers, including biodegradable polymers, using the process of reactive extrusion. Reactive extrusion is an attractive route for polymer processing in order to carry out melt-blending, and various reactions including polymerization, grafting, branching and functionalization as well (See, for example, Mani, R., et al., J. Polymer Sci.: Part A: Polymer Chem., 1999, 37, 1693-1702; Michaeli, W., et al., J. Appl. Polymer Sci., 1993, 48, 871-886; Kye, H., et al., J. of Appl. Polymer Sci., 1994, 52, 1249-1262; U.S. Pat. No. 5,412,005; Carlson, D., et al., J. Appl. Polymer Sci., 1999, 72, 477-485; U.S. Pat. No. 6,114,076; U.S. Pat. No. 6,579,934 and U.S. Pat. No. 5,906,783). Free radical chemical reaction through reactive extrusion has been performed on polypropylene and polyethylene backbones, leading to controlled degradation and branching (See, for example, U.S. Pat. No. 4,857,600 and U.S. Pat. No. 5,346,963).

Copolymerization by reactive extrusion is an important process in the production of new copolymers, in part because the properties, namely the phase behavior, optical and mechanical properties of the newly formed copolymer can be altered based on the degree of copolymerization (also referred to as induced compatibility) of the polymers being combined in the reactive extrusion process. In addition, the economics of using the extruder for conducting chemical modifications has shown that the extrusion technique efficiently affords low cost production and processing, which enhances the commercial viability and cost-competitiveness of these polymers. The benefits of reactive extrusion for the formation of biodegradable materials has been described (See, for example, Raquez, et al., “Biodegradable materials by reactive extrusion: from catalyzed polymerization to functionalization and blend compatibilization,” C. R. Chimie, 2006, 9, 1370-1379).

Resulting copolyesters from transesterification are composed of repeat units from both the ω-hydroxyfatty acid copolyester and the second polyester. The sequence distribution of resulting copolyesters can vary from random to block copolymers and any intermediate degree of block character (e.g. multiblocks where sequences have varying average sequence lengths). Methods for performing reactive trans esterification are well known to those skilled in the art. A number of catalysts may be employed to compatibilize or modify the blend structure by transesterification. These catalysts include but are not limited to inorganic oxycompounds such as alkoxides, phenoxides, enolates or carboxylates of calcium, aluminum, titanium, zirconium, tin, antimony or zinc. A typical family of catalysts known in the art to promote transesterification are aluminum trialkoxides.

Thermally induced compatibility in polyester blends has also been described. Medina, et al., in “Mechanism and kinetics of transesterification in poly(ethylene terephthalate) and poly(ethylene 2,6-naphthalene dicarboxylate) polymer blends,” Polymer, 2004, 45, 8517-8522, describe the temperature-induced transesterification of poly(ethylene terephthalate) and poly(ethylene 2,6-naphthalene dicatboxylate). Transesterification catalysts have also been employed to promote trans esterification between the polyesters subjected to reactive extrusion. For example, Zhou, et al. describe improved transesterification kinetics of liquid crystalline polyesters and poly(ethylene terephthalate) in reactive blends using bis(2-oxazoline) (BOZ) as a chain extender (Zhou, et al., Transesterification kinetics in the reactive blends of liquid crystalline copolyesters and poly(ethylene terephthalate),” European Polymer Journal, 2002, 38, 1049-1053).

U.S. Patent Application No. 2007/0203261 entitled “Reactively Blended Polyester and Filler Composite Compositions and Process,” which is incorporated herein by reference in its entirety, describes the formation of biodegradable thermoplastic polyesters using reactive extrusion processing. Methods and apparatus for the formation of polyester composites by reactive melt-blending (reactive extrusion) in the presence of catalyst are described.

U.S. Pat. No. 6,552,124 entitled “Method of Making a Polymer Blend Composition by Reactive Extrusion and U.S. Pat. No. 7,053,151 entitled “Grafted Biodegradable Polymer Blend Compositions,” which are incorporated herein by reference in their entirety, describe the formation of grafted polymer blends of biodegradable polymers using reactive extrusion. In these two examples of reactive extrusion, a radical initiator is added in order to promote grafting between the polymer chains of the different polymers in order to produce a new polymer with different properties. Methods to make polyester blends are described by a melt phase reaction in which a molten polyester is reacted with a free radical initiator and a polar monomer or mixture of two or more polar monomers, particularly polar vinyl monomers. The melt phase modification is termed “reactive extrusion” in that a new polymer species is created upon the modification reaction.

There are several specific methods for carrying out the grafting modification reaction in a melt. First, all of the ingredients, including a polyester containing some content of ω-hydroxyfatty acid repeat units, a free radical initiator, a polar monomer or a mixture of polar monomers in a predetermined ratio are added simultaneously to a melt mixing device or an extruder. Second, the polyester with OJ-hydroxyfatty acid repeat units may be fed to a feeding section of a twin screw extruder and subsequently melted, and a mixture of a free radical initiator and polar monomer or mixture of polar monomers, is injected into the biodegradable polymer melt under pressure, the resulting melt mixture is then allowed to react. Third, the polyester with ω-hydroxyfatty acid repeat units is fed to the feeding section of a twin screw extruder, then the free radical initiator and polar monomer, or mixture of monomers, are fed separately into the twin screw extruder at different points along the length of the extruder. The heated extruder extrusion is performed under high shear and intensive dispersive and distributive mixing resulting in a grafted blend of polyesters of high uniformity.

Blends of the present invention may be substantially free of surfactants, plasticizers, compatibilizers, catalysts and inorganic fillers. In addition, inorganic fillers and/or plasticizers may be added to the blends.

If desired, the copolyesters of the present invention or blends comprising copolyesters of the present invention can be filled with inorganic, organic and/or clay fillers such as, for example, wood flour, gypsum, talc, mica, carbon black, wollastonite, montmorillonite minerals, chalk, diatomaceous earth, sand, gravel, crushed rock, bauxite, limestone, sandstone, aerogels, xerogels, micro spheres, porous ceramic spheres, gypsum dihydrate, calcium aluminate, magnesium carbonate, ceramic materials, pozzolamic materials, zirconium compounds, xonotlite (a crystalline calcium silicate gel), perlite, vermiculite, hydrated or unhydrated hydraulic cement particles, pumice, zeolites, kaolin, clay fillers, including both natural and synthetic clays and treated and untreated clays, such as organoclays and clays which have been surface treated with silanes and stearic acid to enhance adhesion with the copolyester matrix, smectite clays, magnesium aluminum silicate, bentonite clays, hectorite clays, silicon oxide, calcium terephthalate, aluminum oxide, titanium dioxide, iron oxides, calcium phosphate, barium sulfate, sodium carbonate, magnesium sulfate, aluminum sulfate, magnesium carbonate, barium carbonate, calcium oxide, magnesium oxide, aluminum hydroxide, calcium sulfate, barium sulfate, lithium fluoride, polymer particles, powdered metals, pulp powder, cellulose, starch, chemically modified starch, thermoplastic starch, lignin powder, wheat, chitin, chitosan, keratin, gluten, nut shell flour, wood flour, corn cob flour, calcium carbonate, calcium hydroxide, glass beads, hollow glass beads, sea gel, cork, seeds, gelatins, wood flour, saw dust, agar-based materials, reinforcing agents, such as glass fiber, natural fibers, such as sisal, hemp, cotton, wool, wood, flax, abaca, sisal, ramie, bagasse, and cellulose fibers, carbon fibers, graphite fibers, silica fibers, ceramic fibers, metal fibers, stainless steel fibers, recycled paper fibers, for example, from repulping operations, and mixtures derived therefrom. Fillers can increase the Young's modulus, improve the dead-fold properties, improve the rigidity of the film, coating or laminate, decrease the cost, and reduce the tendency of the film, coating, or laminate to block or self-adhere during processing or use. The use of fillers has been found to produce plastic articles which have many of the qualities of paper, such as texture and feel, as disclosed by, for example, Miyazaki, et. al., in U.S. Pat. No. 4,578,296, which is incorporated by reference herein in its entirety.

Exemplary plasticizers, which may be added to improve processing and/or final mechanical properties, or to reduce rattle or rustle of the films, coatings, or laminates made from the copolyesters, include soybean oil, epoxidized soybean oil, corn oil, castor oil, linseed oil, epoxidized linseed oil, mineral oil, alkyl phosphate esters, plasticizers sold under the trademark “Tween” including Tween® 20 plasticizer, Tween® 40 plasticizer, Tween® 60 plasticizer, Tween® 80 plasticizer, Tween® 85 plasticizer, sorbitan monolaurate, sorbitan monooleate, sorbitan monopalmitate, sorbitan trioleate, sorbitan monostearate, citrate esters, such as trimethyl citrate, triethyl citrate (Citroflex® 2, produced by Morflex, Inc. Greensboro, N.C.), tributyl citrate (Citroflex® 4, produced by Morflex, Inc., Greensboro, N.C.), trioctyl citrate, acetyltri-n-butyl citrate (Citroflex® A4, produced by Morflex, Inc., Greensboro, N.C.), acetyltriethyl citrate (Citroflex® A-2, produced by Morflex, Inc., Greensboro, N.C.), acetyltri-n-hexyl citrate (Citroflexe A-6, produced by Morflex, Inc., Greensboro, N.C.), and butyryltri-n-hexyl citrate (Citroflex® B-6, produced by Morflex, Inc., Greensboro, N.C.), tartarate esters, such as dimethyl tartarate, diethyl tartarate, dibutyl tartarate, and dioctyl tartarate, poly(ethylene glycol), derivatives of poly(ethylene glycol), paraffin, monoacyl carbohydrates, such as 6-0-sterylglucopyranoside, glyceryl monostearate, Myvaplex® 600 (concentrated glycerol monostearates), Nyvaplex® (concentrated glycerol monostearate which is a 90% minimum distilled monoglyceride produced from hydrogenated soybean oil and which is composed primarily of stearic acid esters), Myvacet (distilled acetylated mono glycerides of modified fats), Myvacet® 507 (48.5 to 51.5 percent acetylation), Myvacet® 707 (66.5 to 69.5 percent acetylation), Myvacet® 908 (minimum of 96 percent acetylation), Myverol® (concentrated glyceryl monostearates), Acrawax®, N,N-ethylene bis-stearamide, N,N-ethylene bis-oleamide, dioctyl adipate, diisobutyl adipate, diethylene glycol dibenzoate, dipropylene glycol dibenzoate, polymeric plasticizers, such as poly(1,6-hexamethylene adipate), poly(ethylene adipate), Rucoflex®, and other compatible low molecular weight polymers and mixtures derived therefrom. Preferably, the plasticizers are nontoxic and biodegradable and/or bioderived. Any additive known for use in polymers can be used.

The additives, fillers or blend materials can be added before the polymerization process, at any stage during the polymerization process and/or in a post polymerization process. Any known filler material can be used.

Exemplary suitable clay fillers include kaolin, smectite clays, magnesium aluminum silicate, bentonite clays, montmorillonite clays, hectorite clays, and mixtures derived therefrom. The clays can be treated with organic materials, such as surfactants, to make them organophilic. Examples of suitable commercially available clay fillers include Gelwhite MAS 100, a commercial product of the Southern Clay Company, which is defined as a white smectite clay, (magnesium aluminum silicate); Claytone 2000, a commercial product of the Southern Clay Company, which is defined as an organophilic smectite clay; Gelwhite L, a commercial product of the Southern Clay Company, which is defined as a montmorillonite clay from a white bentonite clay; Cloisite 30 B, a commercial product of the Southern Clay Company, which is defined as an organophilic natural montmorillonite clay with bis(2-hydroxyethyl)methyl tallow quarternary ammonium chloride salt; Cloisite Na, a commercial product of the Southern Clay Company, which is defined as a natural montmorillonite clay; Garamite 1958, a commercial product of the Southern Clay Company, which is defined as a mixture of minerals; Laponite RDS, a commercial product of the Southern Clay Company, which is defined as a synthetic layered silicate with an inorganic polyphosphate peptiser; Laponite RD, a commercial product of the Southern Clay Company, which is defined as a synthetic colloidal clay; Nanomers, which are commercial products of the Nanocor Company, which are defined as montmorillonite minerals which have been treated with compatibilizing agents; Nanomer 1.24 TL, a commercial product of the Nanocor Company, which is defined as a montmorillonite mineral surface treated with amino acids; “P Series” Nanomers, which are commercial products of the Nanocor Company, which are defined as surface modified montmorillonite minerals; Polymer Grade (PG) Montmorillonite PGW, a commercial product of the Nanocor Company, which is defined as a high purity alumina silicate mineral, sometimes referred to as a phyllosilicate; Polymer Grade (PG) Montmorillonite PGA, a commercial product of the Nanocor Company, which is defined as a high purity aluminosilicate mineral, sometimes referred to as a phyllosilicate; Polymer Grade (PG) Montmorillonite PGV, a commercial product of the Nanocor Company, which is defined as a high purity aluminosilicate mineral, sometimes referred to as a phyllosilicate; Polymer Grade (PG) Montmorillonite PGN, a commercial product of the Nanocor Company, which is defined as a high purity aluminosilicate mineral, sometimes referred to as a phyllosilicate; and mixtures derived therefrom. Any clay filler known can be used. Some clay fillers can exfoliate, providing nanocomposites. This is especially true for the layered silicate clays, such as smectite clays, magnesium aluminum silicate, bentonite clays, montmorillonite clays, hectorite. clays, As discussed above, such clays can be natural or synthetic, treated or not.

The particle size of the filler can be within a wide range. As one skilled within the art will appreciate, the filler particle size can be tailored to the desired use of the filled copolyester composition. It is generally preferred that the average diameter of the filler be less than about 40 microns, more preferably less than about 20 microns. However, other filler particle sizes can be used. The filler can include particle sizes ranging up to 40 mesh (US Standard) or larger. Mixtures of filler particle sizes can also be advantageously used. For example, mixtures of calcium carbonate fillers having average particle sizes of about 5 microns and of about 0.7 microns may provide better space filling of the filler within the copolyester matrix. The use of two or more filler particle sizes can allow improved particle packing Two or more ranges of filler particle sizes can be selected such that the space between a group of large particles is substantially occupied by a selected group of smaller filler particles. In general, the particle packing will be increased whenever any given set of particles is mixed with another set of particles having a particle size that is at least about 2 times larger or smaller than the first group of particles. The particle packing density for a two-particle system will be maximized whenever the size of a given set of particles is from about 3 to about 10 times the size of another set of particles. Optionally, three or more different sets of particles can be used to further increase the particle packing density. The optimal degree of packing density depends on a number of factors such as, for example, the types and concentrations of the various components within both the thermoplastic phase and the solid filler phase; the film-forming, coating or lamination process used; and the desired mechanical, thermal and other performance properties of the final products to be manufactured. Andersen, et. al., in U.S. Pat. No. 5,527,387, discloses particle packing techniques, and is incorporated by reference herein in its entirety. Filler concentrates which incorporate a mixture of filler particle sizes are commercially available by the Shulman Company under the trade name Papermatch®.

The filler can be added to the copolyester at any stage during the polymerization or after the polymerization is completed. For example, the fillers can be added with the copolyester monomers at the start of the polymerization process. This is preferable for, for example, the silica and titanium dioxide fillers, to provide adequate dispersion of the fillers within the polyester matrix. Alternatively, the filler can be added at an intermediate stage of the polymerization such as, for example, as the pre-condensate passes into the polymerization vessel. As yet a further alternative, the filler can be added after the copolyester exits the polymerizer. For example, the copolyester can be melt fed to any intensive mixing operation, such as a static mixer or a single- or twin-screw extruder and compounded with the filler.

Blends of the present invention may further include various non-polymeric components including among others nucleating agents, anti-block agents, antistatic agents, slip agents, antioxidants, pigments or other inert fillers and the like. These additions may be employed in conventional amounts, although typically such additives are not required in the composition in order to obtain the toughness, ductility and other attributes of these materials. One or more of these non-polymeric components may be employed in the compositions in conventional amounts known to one skilled in the art.

Coupling, compatibilizing or mixing agents may be added to the reactive extrusion process in order to promote the interfacial adhesion thereof between the polymers and/or with optional fillers. Preferably, the copolyesters are modified by free radical grafting of unsaturated compounds including polar monomers such as maleic anhydride or esters, acrylic or methacrylic acid or esters, vinylacetate, acrylonitrile, and styrene. Virtually any olefinically reactive residue that can provide a reactive functional group on modified biodegradable thermoplastic polyesters can be useful in the invention.

The copolyesters of the present invention or blends comprising copolyesters of the present invention may be used with, or contain, one or more additives. It is preferred that the additives are nontoxic, biodegradable and bio-benign. Such additives include thermal stabilizers such as, for example, phenolic antioxidants; secondary thermal stabilizers such as, for example, thioethers and phosphates; UV absorbers such as, for example, benzophenone- and benzotriazole-derivatives; and UV stabilizers such as, for example, hindered amine light stabilizers (HALS). Other additives include plasticizers, processing aids, flow enhancing additives, lubricants, pigments, flame retardants, impact modifiers, nucleating agents to increase crystallinity, antiblocking agents such as silica, and base buffers such as sodium acetate, potassium acetate, and tetramethyl ammonium hydroxide, (for example, as disclosed in U.S. Pat. Nos. 3,779,993, 4,340,519, 5,171,308, 5,171,309, and 5,219,646 and references cited therein, which are incorporated by reference herein in their entireties).

The copolyesters and copolyester blends of the present invention can be converted to dimensionally stable objects selected from the group consisting of films, fibers, foamed objects and molded objects. Furthermore, they can be converted to thin films by a number of methods known to those skilled in the art. For example, thin films can be formed by dipcoating as described in U.S. Pat. Nos. 4,372,311, by compression molding as described in 4,427,614, by melt extrusion as described in 4,880,592, and by melt blowing (extrusion through a circular die). All three patents are incorporated by reference herein in their entireties. Films can be also prepared by solvent casting. Solvents that may dissolve these copolyesters and, if so, would be suitable for casting, include methylene chloride, chloroform, other chlorocarbons, and tetrahydrofuran. In addition, it is possible to produce uniaxially and biaxially oriented films by a melt extrusion process followed by orientation of the film. Copolyesters of this invention are preferably processed in a temperature range of 10° C. to 30° c. above their melting temperatures. Orientation of films is best conducted in the range of −10° C. below to 100° C. above the copolyester melting temperature.

Films prepared from the copolyesters of the present invention will have relatively low water vapor transmission rates (WVTR), are ductile (flexible), have good elongations (will stretch before breaking) and good tear strengths relative to other biodegradable films. U.S. Pat. No. 7,153,569 entitled “Biodegradable Aliphatic-Aromatic Copolyester Films,” which is incorporated herein by reference in its entirety, describes several biodegradable copolyester films and their properties.

The copolyester component of the films of the present invention have a weight average molecular weight and a number average molecular weight such that the copolyester has a suitable tensile strength. If the molecular weight numbers are too small, the copolyester will be too tacky and have too low tensile strength and elongation at break values. If the molecular weight numbers are too high, various processing issues, such as a need for increased temperature to deal with increased viscosity, are encountered. Suitable weight average molecular weights for the copolyesters are from about 90,000 to about 160,000 Daltons, preferably from about 100,000 to about 130,000 Daltons, and more preferably from about 105,000 to about 120,000 Daltons. Suitable number average molecular weights for the copolyesters are from about 35,000 to about 90,000 Daltons, preferably from about 40,000 to about 70,000 Daltons, and more preferably from about 45,000 to about 65,000 Daltons.

The copolyesters described herein for use in the films of the present invention will generally have a glass transition temperature such that the copolyester has suitable flexibility characteristics for use in a film. In one embodiment, the copolyesters of the present invention will have a glass transition temperature of less than about 0° C., and optionally less than about −10° C.

The hydroxyfatty acid copolyesters can also be injection molded. The copolyesters of the present invention can be molded into numerous types of flexible objects, such as bottles, pen barrels, toothbrush handles, cotton swab applicators and razor blade handles. They can also be used to prepare foamed food service items. Examples of such items include cups, plates, and food trays. The term “biodegradable” or “biodegradable polymer” generally refers to a polymer that can be readily decomposed by biological means, such as a microbial action, environmental exposure, heat and/or moisture. When tested according to ASTM D6340-98, a biodegradable polymer is one that is at least about 80% dissolved and/or decomposed after 180 days in a controlled compost environment as set forth in the procedure. Copolyesters with greater than 50 wt % ω-hydroxyfatty acid content are expected to be biodegradable, but the actual rate and extent of biodegradation will vary with copolymer composition. In general, copolyesters with monomers whose homopolymers degrade rapidly are expected to provide copolyesters with increased degradation rates, and copolyesters with monomers whose homo- or copolyesters are non-degradable, or slowly biodegrade, are expected to provide copolyesters with decreased degradation rates.

Biodegradable materials, such as many of the copolyester compositions of the present invention, are initially reduced in molecular weight in the environment by the action of heat, water, air, microbes and other factors. This reduction in molecular weight results in a loss of physical properties (film strength) and often in film breakage. Once the molecular weight of the copolyester is sufficiently low, the monomers and oligomers are then assimilated by the microbes. In an aerobic environment, these monomers or oligomers are ultimately oxidized to C02, H20, and new cell biomass. In an anaerobic environment the monomers or oligomers are ultimately oxidized to CO2, H2, acetate, methane, and cell biomass. Successful biodegradation requires that direct physical contact must be established between the biodegradable material and the active microbial population or the enzymes produced by the active microbial population. An active microbial population useful for degrading the films and blends of the invention can generally be obtained from any municipal or industrial wastewater treatment facility or composting facility. Moreover, successful biodegradation requires that certain minimal physical and chemical requirements be met such as suitable pH, temperature, oxygen concentration, proper nutrients, and moisture level. The poly(hydroxyfatty acid-ω-diacid/diol) copolyesters of the present invention are expected to be biodegradable in composting environments and, hence, would be particularly useful in the preparation of barrier films in disposable articles.

Composting can be defined as the microbial degradation and conversion of solid organic waste into soil. One of the key characteristics of compost piles is that they are self-heating; heat is a natural by-product of the metabolic break down of organic matter. Depending upon the size of the pile, or its ability to insulate, the heat can be trapped and cause the internal temperature to rise. Efficient degradation within compost piles relies upon a natural progression or succession of microbial populations to occur. Initially, the microbial population of the compost is dominated by mesophilic species (optimal growth temperatures between 20-45° C.).

The process begins with the proliferation of the indigenous mesophilic microflora and metabolism of the organic matter. This results in the production of large amounts of metabolic heat which raise the internal pile temperatures to approximately 55-65° C. The higher temperature acts as a selective pressure which favors growth of thermophilic species on one hand (optimal growth range between 45-60° C.), while inhibiting the mesophiles on the other.

Although the temperature profiles are often cyclic in nature, alternating between mesophilic and thermophilic populations, municipal compost facilities attempt to control their operational temperatures between 55-60° C. in order to obtain optimal degradation rates. Municipal compost units are also typically aerobic processes, which supply sufficient oxygen for the metabolic needs of the microorganisms permitting accelerated biodegradation rates.

This invention can be further illustrated by the following examples of preferred embodiments thereof, although it will be understood that these examples are included merely for purposes of illustration and are not intended to limit the scope of the invention unless otherwise specifically indicated. The starting materials are commercially available unless otherwise described. All percentages are by weight unless otherwise described.

### EXAMPLES

Abbreviations used herein are as follows: “IV” is inherent viscosity; “g” is gram; “psi” is pounds per square inch; “cc” is cubic centimeter; “m” is meter; “rpm” is revolutions per minute; “BOD” is biochemical oxygen demand; “vol.” or “v” is volume; “wt.” is weight; “μm” is micrometer; “WVTR” is water vapor transmission rate; “mil” is 0.001 inch; “T_{g}” is glass transition temperature; “Tₘ” is melting temperature; “DEG” is diethylene glycol; “EG” is ethylene glycol; “PEG” is poly(ethylene glycol); “OPC” is gel permeation chromatography; “Mₙ” is number average molecular weight; “M_{w}” is weight average molecular weight; “M_{z}” is Z-average molecular weight; “NMR” is nuclear magnetic resonance spectroscopy; “DSC” is differential scanning calorimetry.

Tensile strength, elongation at break, and tangent modulus of the films can be measured by ASTM method D882; the tear force is measured by ASTM method D1938; the oxygen and water vapor transmission rates are measured by ASTM methods D3985 and F372, respectively. Inherent viscosities can be measured at a temperature of 25° C. for a 0.500 gram sample in 100 mL of a 60/40 by weight solution of phenol/tetrachloroethane. DSC measurements are usually made at a scan rate of 20° C./min. Molecular weights can be measured by gel permeation chromatography and are most commonly based on polystyrene equivalent molecular weights.

The composition of the copolyesters is given in brackets following the name. For example, poly(ω-hydroxyfatty acid-ω-diacidldiol) [83/12/5] refers to a copolyester which was prepared from 83% ω-hydroxyfatty acid, 12% diacid and 5% diol. The percent composition refers to percent by weight.

### Example 1

### Preparation of Poly(14-Hydroxytetradecanoic Acid-Co-Tetradecanedioic Acid/Diethylene Glycol) [83/12/5]

A 500 mL single-neck round bottom flask is charged with 14-hydroxytetradecanoic acid (122 g, 0.5 mole), diethylene glycol (7.4 g, 0.07 mole), tetradecanedioic acid (18 g, 0.07 mole) and 1.4 ml of a solution containing titanium isopropoxide (1.25 wt/vol % Ti). The flask is fitted with a metal stirrer and a nitrogen inlet and then immersed in a Belmont metal bath. The mixture is heated with stirring under an inert atmosphere, such as nitrogen, at 200° C. for 1.0 hour, at 210° C. for 1.0 hour, and at 220° C. for 1.0 hour. The reaction temperature is then increased to 250° C. After stabilizing at 250° C., the internal pressure is reduced to 0.3 mm Hg, and the reaction is allowed to progress for 2.0 hrs. The resulting copolyester may be semicrystalline and can be isolated using standard techniques. The copolyester may be analyzed using standard methods well known to those of ordinary skill in the art. For example, IV (dL/g), T_{g} (° C.) and Tₘ (° C.) analysis can be performed using DSC, mole % DEG can be determined by NMR, and Mₙ and M_{w} values may be obtained using GPC.

### Example 2

### Preparation of Poly(14-Hydroxytetradecanoic Acid-Co-Tetradecanedioic Acid/Trimethylol Propane) [99.2/0.6/0.2]

A 500 mL single-neck round bottom flask is charged with 14-hydroxytetradecanoic acid methyl ester (129 g, 0.5 mole), trimethylol propane (0.27 g, 0.002 mole), tetradecanedioic acid (0.8 g, 0.003 mole) and 1.5 ml of a solution containing titanium isopropoxide (1.25 wt/vol % Ti). The flask is fitted with a metal stirrer and a nitrogen inlet and is then immersed in a Belmont metal bath. The mixture is heated with stirring under an inert atmosphere, such as nitrogen, at 200° C. for 1.0 hour, at 210° C. for 1.0 hour, and at 220° C. for 1.0 hour. The reaction temperature is then increased to 250° C. After stabilizing at 250° C., the internal pressure is reduced to 0.3 mm Hg, and the reaction is allowed to progress for 2.0 hrs. The resulting copolyester may be semi crystalline and is isolated using standard techniques. The copolyester may be analyzed using standard methods well known to those of ordinary skill in the art. For example, IV (dL/g), T_{g} (° C.) and Tₘ (° C.) analysis can be performed using DSC, mole % DEG can be determined by NMR, and Mₙ and M_{w} values may be obtained using GPC.

### Example 3

### Preparation of Poly(ω-Hydroxyfatty Acid-Co-Terephthalic Acid/Butane Diol) [50/33/17]

A 500 mL single-neck round bottom flask is charged with a mixture of ω-hydroxyfatty acids produced by fermenting palm oil with an engineered yeast strain (125 g), butane diol (43 g, 0.48 mole), terephthalic acid (80 g, 0.48 mole) and 1.4 ml of a chloroform solution containing titanium isopropoxide (1.25 wt/vol % Ti). The flask is fitted with a metal stirrer and a nitrogen inlet and then immersed in a Belmont metal bath. The mixture is heated with stirring under an inert atmosphere, such as nitrogen, at 200° C. for 1.0 hour, at 210° C. for 1.0 hour, and at 220° C. for 1.0 hour. The reaction temperature is then increased to 250° C. After stabilizing at 250° C., the internal pressure is reduced to 0.3 mm Hg, and the reaction is allowed to progress for 2.0 hrs. The resulting copolyester may be semicrystalline and can be isolated using standard techniques. The copolyester may be analyzed using standard methods well known to those of ordinary skill in the art. For example, IV (dL/g), T_{g} (° C.) and Tₘ (° C.) analysis can be performed using DSC, mole % DEG can be determined by NMR, and Mₙ and M_{w} values may be obtained using GPC.

### Example 4

### Preparation of Poly(14-Hydroxytetradecanoic Acid)

A 500 mL single-neck round bottom flask is charged with 14-hydroxytetradecanoic acid (48.8 g, 0.2 mole), and 2.27 mL of a 1-butanol solution containing titanium isopropoxide (10 mg/mL). The flask is fitted with a metal stirrer and a nitrogen inlet and then immersed in a Belmont metal bath. The reaction mixture is heated with stirring under an inert atmosphere, such as nitrogen, at 200° C. for 2.0 hours. The reaction temperature is then increased to 220° C. After stabilizing at 220° C., the internal pressure is reduced to 0.1 mm Hg, and the reaction is allowed to continue for 4.0 hours. The isolated product provides a T_{g} of −31° C. (by DMTA), a Tₘ of 91° C. (by DSC), and a M_{w} of 170,000 (by GPC). In addition, results from tensile testing of compression molded bars provide a Young's Modulus of 426±46 MPa, an elongation at break of 728±80%, and a stress at break value of 15.1±28 MPa.

### Example 5

### Preparation of Poly(16-Hydroxyhexadecanoic Acid)

A 500 mL single-neck round bottom flask is charged with 16-hydroxyhexadecanoic acid (54.4 g, 0.2 mole) and 2.27 mL 1-butanol solution containing titanium isopropoxide (10 mg/mL). The flask is fitted with a metal stirrer and a nitrogen inlet and then immersed in a Belmont metal bath. The reaction mixture is heated with stirring under an inert atmosphere, such as nitrogen, at 200° C. for 2.0 hours. The reaction temperature is then increased to 220° C. After stabilizing at 220° C., the internal pressure is reduced to 0.1 mm Hg, and the reaction is continued for 4.0 hours. The isolated product has a Tₘ value of 98° C. (by DSC) and a M_{w} of 180,000 (by GPC). In addition, results from tensile testing of compression molded bars provide a Young's Modulus of 377±20 MPa, an elongation at break value of 370±130%, and a stress at break value of 15.8±1.0 MPa.

### Example 6

### Preparation of Poly(18-Hydroxyoctadecanoic Acid)

A 500 mL single-neck round bottom flask is charged with 18-hydroxyoctadecanoic acid (60 g, 0.2 mole), and 2.27 mL of a 1-butanol solution containing titanium isopropoxide (10 mg/mL). The flask is fitted with a metal stirrer and a nitrogen inlet and then immersed in a Belmont metal bath. The reaction mixture is heated with stirring under an inert atmosphere, such as nitrogen, at 200° C. for 2.0 hours. The reaction temperature is then increased to 220° C. After stabilizing at 220° C., the internal pressure is reduced to 0.1 mm Hg, and the reaction is allowed to progress for 4.0 hours. The isolated product has a Tₘ of 102° C. (by DSC) and a M_{w} of 230,000 (by GPC). In addition, tensile testing of compression molded bars provide a Young's Modulus of 447±40 MPa, an elongation at break of 522±80%, and a stress at break of 17.9±3.9 MPa by tensile test.

### Example 7

### Preparation of Poly(16-Hydroxyhexadecanoic Acid-Co-18-Hydroxyoctadecanoic Acid) [47.5/52.5]

A 500 mL single-neck round bottom flask is charged with 16-hydroxyoctadecanoic acid (27.2 g, 0.1 mole), 18-hydroxyoctadecanoic acid (30.0 g, 0.1 mole) and 2.27 mL of a 1-butanol solution containing titanium isopropoxide (10 mg/mL). The flask is fitted with a metal stirrer and a nitrogen inlet and then immersed in a Belmont metal bath. The mixture is heated with stirring under an inert atmosphere, such as nitrogen, at 200° C. for 2.0 hours. The reaction temperature is then increased to 220° C. After stabilizing at 220° C., the internal pressure is reduced to 0.1 mm Hg, and the reaction is allowed to progress for 4.0 hours. Analysis of the isolated product provides a Tₘ of 99.3° C. using DSC.

### Example 8

### Preparation of Poly(14-Hydroxytetradecanoic Acid-Co-Lactide)[50/50]

A 500 mL single-neck round bottom flask is charged with 14-hydroxytetradecanoic acid (48.8 g, 0.2 mole), and 2.27 mL of a 1-butanol solution containing titanium isopropoxide (10 mg/mL). The flask is fitted with a metal stirrer and a nitrogen inlet and then immersed in a Belmont metal bath. The reaction mixture is heated with stirring under an inert atmosphere, such as nitrogen, at 200° C. for 2.0 hours. The reaction temperature is then increased to 220° C. After stabilizing at 220° C., the internal pressure is reduced to 0.1 mm Hg, and the reaction is allowed to progress for 2.0 hours. When the system cools down to room temperature, lactide (48.8 g, 0.34 mole) and stannous octoate (0.244 g, 0.6 mmole) are added to the system. The reaction flask is then immersed in a silicone oil bath at 140° C., an inert atmosphere is maintained, such as nitrogen, and the reaction is continued for 6.0 hours. The isolated product has a T_{g} of 54.7° C., a Tₘ of 140.7° C. (by DSC) and a M_{w} of 53,000 using GPC.

### Example 9

### Preparation of Poly(14-Hydroxytetradecanoic Acid-Co-1,4-Butanediol-Co-Dimethyl Cyclohexanedicarboxylate)[20/32/48]

A 500 mL single-neck round bottom flask is charged with 14-hydroxytetradecanoic acid (48.8 g, 0.2 mole), 1,4-butanediol (61.0 g 0.67 mole), dimethyl cyclohexanedicarboxylate (134.2 g, 0.67 mole) and titanium butoxide (0.0427 g 0.05 mmole). The reaction flask is fitted with a metal stirrer and a nitrogen inlet and then immersed in a Belmont metal bath. The flask is heated with stirring under an inert atmosphere, such as nitrogen, at 200° C. for 2.0 hours. The reaction temperature is then increased to 220° C. After stabilizing at 220° C., the internal pressure is reduced to 0.1 min Hg, and the reaction is allowed to progress for 3.0 hours. The isolated product has a T_{g} of −27° C., a Tₘ of 131-138° C. (by DSC) and a M_{w} of 121,000 using GPC.

### Example 10

### Preparation of Poly(14-Hydroxytetradecanoic Acid-Co-1,4-Butanediol-Co-Dimethyl Terephthalate)[20/32/48]

A 500 mL single-neck round bottom flask is charged with 14-hydroxytetradecanoic acid (48.8 g, 0.2 mole), 1,4-butanediol (62.0 g 0.69 mole), dimethyl cyclohexanedicarboxylate (133.2 g, 0.69 mole) and titanium butoxide (0.0427 g 0.05 mmole). The reaction flask is fitted with a metal stirrer and a nitrogen inlet and then immersed in a Belmont metal bath. The reaction is heated with stirring under an inert atmosphere, such as nitrogen, at 200° C. for 2.0 hours. The reaction temperature is then increased to 220° C. After stabilizing at 220° C., the internal pressure is reduced to 0.1 mm Hg, and the reaction is allowed to progress for 3.0 hours. Measurements of the isolated product provide a T_{g} of −2° C., a Tₘ of 188° C. (by DSC) and a M_{w} of 84,100 using GPC.

### Example 11

### Preparation of a Reactive Blended Material Prepared from 1:1 (w/w) Poly(ω-Hydroxytetradecanoic Acid) and Poly(Lactic Acid)

A 500 mL three-neck round bottom flask is charged with poly(ω-hydroxytetradecanoic acid) (100 g, 0.132 mol monomer unit) and an 4.0 mL aliquot from a titanium n-butoxide (20 mg/mL) solution. The reaction flask is fitted with a metal stirrer and a nitrogen inlet and then immersed in a Belmont metal bath. The flask is heated with stirring under an inert atmosphere, such as nitrogen, at 220° C. for 5 min in order to uniformly disperse the titanium n-butoxide throughout the poly(ω-hydroxytetradecanoic acid) matrix. Then, the melt is cooled and used for further blending with poly(lactic acid) (PLA-INGEO™ 2002D, Natureworks LLC, Mₙ=11.3×10⁴, d=1.7, Tₘ=152.1° C.). The procedure provides poly(ω-hydroxytetradecanoic acid) with 600 ppm titanium n-butoxide dispersed within the matrix. Poly(ω-hydroxytetradecanoic acid) (5 g) and poly(lactic acid) (5 g) containing titanium n-butoxide are transferred to a 100 mL reactor flask fitted with an overhead metal stirrer and an inlet tube for inert gas. Under inert atmosphere with overhead stirring, the reaction is heated at 220° C. and continued for 2.0 hrs. The resulting reactive blending product has a T_{g} of 64.0° C. (by DMTA) and a Tₘ of 152.2° C. using DSC. In addition, tensile testing of compression molded bars provides a Young's modulus of 598±20 MPa, elongation at break of 120±30% and tensile strength of 17.7±0.7 MPa.

### Example 12

Blown film from a copolyester of the present invention is produced using a laboratory scale blown film line which consists of a Killion 1.25 inch extruder with a 15:1 gear reducer. Optimally the copolyester is dried overnight between 50 and 60° C. in dehumidified air dryers prior to processing. The screw is a Maddock mixing type with an L/D of 24 to 1, although a general purpose screw can also be used. Compression ratio for the mixing screw is 3.5:1 and a 1.21 inch diameter die with a 5 mil die gap is used. The air ring is a Killion single-lip, No. 2 type. A variety of conditions are possible for producing melt blown films from the copolyesters of this invention. Temperature set points for the extruders can vary depending on the level of inert additives, if any, but are generally in the range of 10°-30° C. above the melting point of the copolyester. For example, if the level of inert additives is approximately 6 wt % (average diameter of inert particles was less than 10 microns), all heater zones are set between 105°-110° C. with a screw rpm of 20 to 25. Superior performance is generally obtained at the lowest operating temperature possible. Blowing conditions can be characterized by the blow up ratio (BUR), the ratio of bubble diameter to die diameter which gives an indication of hoop or transverse direction (TD) stretch; and the draw-down ratio (DDR), which is an indication of the axial or machine direction (MD) stretch. Prior to processing, the copolyesters are dried overnight at 50° C. in dehumidified air dryers. Physical properties of the film including elongation at break (%), tangent modulus (psi) and tensile strength (psi) can be measured.

### Example 13

Films can also be solvent cast from the copolyesters of the present invention. The copolyesters are dried either under vacuum or by desiccant drying and dissolved in either chloroform or methylene chloride at a concentration of 10-20 wt %. The films are cast on stainless steel plates and are drawn down to approximately 15 mil with a “doctor” blade. The solvent is evaporated slowly to leave films of approximately 1.5 mil in thickness. Physical properties of the solvent cast films including IV (dL/g), elongation at break (%), tangent modulus (psi) and tensile strength (psi) can be measured.

### Example 14

In order to assess the biodegradation potential of the test films, small-scale compost units are employed to simulate the active treatment processes found in a municipal solid waste composter. These bench-scale units display the same key features that distinguish the large-scale municipal compost plants. The starting organic waste is formulated to be representative of that found in municipal solid waste streams: a carbon to nitrogen of 25:1 ratio, a 55% moisture content, a neutral pH, a source of readily degradable organic carbon (e.g. cellulose, protein, simple carbohydrates, and lipids), and a particle size to allow air flow through the mass. Prior to being placed in a compost unit, all test films are optimally dried and weighed. Test films are mixed with the compost at the start of an experiment and incubated with the compost for 15 days. The efficiency of the bench scale compost units are determined by monitoring the temperature profiles and dry weight disappearance of the compost. Films are harvested after 15 days of incubation and washed, dried, and weighed to determine weight loss. Biodegradation can be measured by film weight loss, and/or loss of molecular weight, after composting.

### Example 15

The ω-hydroxyfatty acid copolyesters of the present invention can also be injection molded, for example, on a Toyo 90-1. The copolyester is dried in a desiccant dryer at about 60° C. for approximately 16 hours prior to injection molding. Exemplary molding conditions are Open Cycle Time (4 sec), Inject+Hold Time (20 sec), Cooling Time (50 sec), Inject Time (4 sec), Total Cycle Time (78 sec), Nozzle Temp. (120° C.), Zone 1 Temp. (120° C.), Zone 2 Temp. (120° C.), Zone 3 Temp. (120° C.), Zone 4 Temp. (110° C.), Injection Pressure (600 psi), Hold Pressure (600 psi), Mold Temp. (12° C.), Clamping force (90 tons), Screw speed (93 rpm) and Mode Regular Nozzle Straight. Physical properties of the molded plastic such as Elongation at Break (%), Tensile Strength (psi), Flexural Strength (psi), Flexural Modulus (psi), Izod Impact (Notched, 23° C.; ft-Ib/in), LV (dL/g), and Rockwell Hardness (R Scale) can be measured.

The present invention has been described with particular reference to preferred embodiments thereof, however, it will be understood by a person skilled in the art that variations and modifications can be effected within the spirit and scope of the invention. Moreover, all patents, patent applications (published or unpublished, foreign or domestic), literature references or other publications noted above are incorporated herein by reference for any disclosure pertinent to the practice of this invention.

1. A process for preparing a copolyester which comprises:
(i) admixing one or more ω-hydroxyfatty acids or an ester thereof, produced by fermentation of a feedstock using an engineered yeast strain, with one or more diacids or an ester thereof, one or more diols in a molar amount equal to the one or more diacids, and optionally an additive that is a member selected from the group consisting of a branching agent, an ion-containing monomer, and a filler;
(ii) heating the mixture in the presence of one or more catalysts to between about 180° C. to about 300° C.; and
(iii) recovering the copolyester material.

2. The process of claim 1 wherein the one or more diacids or an ester thereof is an ω-carboxyfatty acid or an ester thereof obtained by fermentation of a feedstock using an engineered yeast strain.

3. The process of claim 1 which comprises heating the mixture for a second time to between about 180° C. to about 260° C. under reduced pressure after the heating step.

4. The process of claim 3 wherein the reduced pressure is between about 0.05 to about 2 mmHg.

5. The process of claim 1 wherein the admixing step comprises one or more hydroxyacids obtained from a synthetic source or a natural source other than the fermentation of a feedstock.

6. The process of claim 1 which comprises selecting the feedstock from a pure fatty acid, a mixture of fatty acids, a pure fatty acid ester, a mixture of fatty acid esters and triglycerides, or a combination thereof.

7. The process of claim 1 wherein the engineered strain of yeast is an engineered strain of Candida tropicalis.

8. The process of claim 7 wherein the engineered strain of Candida tropicalis is selected from Candida tropicalis strains DP1, DP390, DP415, DP417, DP421, DP423, DP434 and DP436.

9. The process of claim 1 where the catalyst is selected from a salt or oxide of Li, Ca, Mg, Mn, Zn, Pb, Sb, Sn, Ge, and Ti.

10. The process of claim 9 wherein the salt is an acetate salt.

11. The process of claim 9 wherein the oxide is selected from an alkoxide or glycol adduct.

12. The process of claim 1 where the catalyst is selected from titanium tetraisopropoxide, titanium tetraethoxide, titanium tetrabutoxide and titanium tetrachloride.

13. (canceled)

14. The process of claim 1 wherein the one or more ω-hydroxyfatty acids or an ester thereof is a member selected from the group consisting of ω-hydroxylauric acid (ω-OH-LA), ω-hydroxymyristic acid (ω-OH-MA), ω-hydroxypalmitic acid (ω-OH-PA), ω-hydroxy palmitoleic acid (ω-OH-POA), ω-hydroxystearic acid (ω-OH-SA), ω-hydroxyoleic acid (ω-OH-OA), ω-hydroxyricinoleic acid (ω-OH-RA), ω-hydroxylinoleic acid (ω-OB-LA), ω-hydroxy-α-linolenic acid, (ω-OH-ALA), ω-hydroxy-γ-linolenic acid (ω-OH-GLA), ω-hydroxybehenic acid (ω-OBBA) and ω-hydroxyerucic acid (ω-OH-EA).

15. The process of claim 1 which comprises one or more ω-hydroxyfatty acids or an ester thereof, or the one or more diacids or an ester thereof, is obtained by partial or complete hydrogenation of the feedstock prior to fermentation of the feedstock or partial or complete hydrogenation after fermentation of the feedstock.

16. The process of claim 1 which comprises selecting the one or more diacids or an ester thereof from ω-carboxyllauric acid (ω-COOH-LA), ω-carboxymyristic acid (ω-COOH-MA), ω-carboxypalmitic acid (ω-COOH-PA), ω-carboxypalmitoleic acid (ω-COOH-POA), ω-carboxystearic acid (ω-COOR-SA), ω-carboxyoleic acid (ω-COOH-OA), ω-carboxyricinoleic acid (ω-COOR-RA), ω-carboxyllinoleic acid (ω-COOR-LA), ω-carboxy-α-linolenic acid (ω-COOH-ALA), ω-carboxy-γ-linolenic acid (ω-COOR-GLA), ω-carboxybehenic acid (ω-COOHBA), ω-carboxyerucic acid (ω-COOR-EA) or a mixture thereof.

17. (canceled)

18. (canceled)

19. (canceled)

20. A process for preparing a copolyester which comprises:
(i) preparing one or more ω-hydroxyfatty acids by fermentation of a feedstock using an engineered yeast strain;
(ii) optionally preparing one or more ω-hydroxyfatty acid esters from the one or more ω-hydroxyfatty acids;
(iii) admixing the one or more ω-hydroxyfatty acids or an ester thereof with one or more diacids or an ester thereof, one or more diols in a molar amount equal to the one or more diacids, and optionally an additive that is a member selected from the group consisting of a branching agent, an ion-containing monomer, and a filler;
(iv) heating the mixture in the presence of one or more catalysts to between about 180° C. to about 300° C.; and
(v) recovering the copolyester material.

21. The process of claim 20 wherein the one or more diacids or an ester thereof is an ω-carboxyfatty acid or an ester thereof obtained by fermentation of a feedstock using an engineered yeast strain.

22. The process of claim 20 which comprises heating the mixture for a second time to between about 180° C. to about 260° C. under reduced pressure after the heating step.

23. The process of claim 22 wherein the reduced pressure is between about 0.05 to about 2 mmHg.

24. The process of claim 20 wherein the admixing step comprises one or more hydroxyacids obtained from a synthetic source or a natural source other than the fermentation of a feedstock.

25. The process of claim 20 which comprises selecting the feedstock from a pure fatty acid, a mixture of fatty acids, a pure fatty acid ester, a mixture of fatty acid esters and triglycerides, or a combination thereof.

26. The process of claim 20 wherein the engineered strain of yeast is an engineered strain of Candida tropicalis.

27. The process of claim 26 wherein the engineered strain of Candida tropicalis is selected from Candida tropicalis strains DP1, DP390, DP415, DP417, DP421, DP423, DP434 and DP436.

28. The process of claim 20 where the catalyst is selected from a salt or oxide of Li, Ca, Mg, Mn, Zn, Pb, Sb, Sn, Ge, and Ti.

29. The process of claim 28 wherein the salt is an acetate salt.

30. The process of claim 28 wherein the oxide is selected from an alkoxide or glycol adduct.

31. The process of claim 20 where the catalyst is selected from titanium tetraisopropoxide, titanium tetraethoxide, titanium tetrabutoxide and titanium tetrachloride.

32. (canceled)

33. (canceled)

34. The process of claim 20 wherein the one or more ω-hydroxyfatty acids or an ester thereof, or the one or more diacids or an ester thereof, is obtained by partial or complete hydrogenation of the feedstock prior to fermentation of the feedstock or partial or complete hydrogenation after fermentation of the feedstock.

35. (canceled)

36. (canceled)

37. The process of claim 20 which comprises selecting the one or more diacids or an ester thereof, from the group consisting of oxalic acid, dimethyl oxalate, malonic acid, dimethyl malonate, succinic acid, dimethyl succinate, methyl succinic acid, itaconic, dimethly itaconic acid, maleic acid, dimethyl maleic acid, fumaric acid, dimethly fumaric acid, glutaric acid, dimethyl glutarate, 2-methylglutaric acid, 3-methylglutaric acid, adipic acid, dimethyl adipate, 3-methyladipic acid, 2,2,5,5-tetramethylhexanedioic acid, pimelic acid, suberic acid, azelaic acid, dimethyl azelate, sebacic acid, 1,11-undecanedicarboxylic acid, 1,1 O -decanedicarboxylic acid, undecanedioic acid, 1,12-dodecanedicarboxylic acid, hexadecanedioic acid, docosanedioic acid, tetracosanedioic acid, dimer acid, 1,4-cyclohexanedicarboxylicacid, dimethyl-1,4-cyclohexanedicarboxylate, 1,3-cyclohexanedicarboxylic acid, dimethyl-1,3-cyclohexanedicarboxylate, 1,1-cyclohexanediacetic acid, 2,5-norbornanedicarboxylic, and mixtures of two or more thereof.

38. The process of claim 20 which comprises selecting the one or more diacids or an ester thereof from the group consisting of terephthalic acid, dimethyl terephthalate, isophthalic acid, dimethylisophthalate, 2,6-napthalene dicarboxylic acid, dimethyl-2,6-naphthalate, 2,7-naphthalenedicarboxylic acid, dimethyl-2,7-naphthalate, 3,4′-diphenyl ether dicarboxylic acid, dimethyl-3,4′diphenyl ether dicarboxylate, 4,4′-diphenyl ether dicarboxylic acid, dimethyl-4,4′diphenyl ether dicarboxylate, 3,4′-diphenyl sulfide dicarboxylic acid, dimethyl-3,4′-diphenyl sulfide dicarboxylate, 4,4′-diphenyl sulfide dicarboxylic acid, dimethyl-4,4′-diphenyl sulfide dicarboxylate, 3,4′-diphenyl sulfone dicarboxylic acid, dimethyl-3,4′-diphenyl sulfone dicarboxylate, 4,4′-diphenyl sulfone dicarboxylic acid, dimethyl-4,4′-diphenyl sulfone dicarboxylate, 3,4′-benzophenonedicarboxylic acid, dimethyl-3,4′-benzophenonedicarboxylate, 4,4′-benzophenonedicarboxylic acid, dimethyl-4,4′-benzophenonedicarboxylate, 1,4-naphthalene dicarboxylic acid, dimethyl-1,4-naphthalate, 4,4′-methylene bis(benzoic acid) and dimethyl-4,4′-methylenebis(benzoate), or a mixture thereof.

39. A process for preparing a copolyester which comprises:
(i) preparing one or more ω-hydroxyfatty acids by fermentation of a feedstock using an engineered yeast strain;
(ii) preparing one or more ω-hydroxyfatty acid lactones or ω-hydroxyfatty acid lactone multimers from the one or more ω-hydroxyfatty acids;
(iii) optionally admixing one or more hydroxyacid lactones or hydroxyacid lactone multimers,
(iv) optionally admixing an additive that is a member selected from the group consisting of a branching agent, an ion-containing monomer, and a filler;
(iv) heating the mixture in the presence of one or more catalysts; and
(v) recovering the copolyester material.

40. The process of claim 39 wherein the one or more hydroxyacid lactones or hydroxyacid lactone multimers is a lactone or lactone multimers of lactic acid, glycolic acid, 3-hydroxypropionic acid, 3-hydroxybutyric acid, 4-hydroxybutyric acid, 6-hydroxyhexanoic acid or a mixture thereof.

41. The process of claim 39 wherein the mixture to between about 120° C. to about 300° C. in the heating step.

42. The process of claim 39 which comprises selecting the feedstock from a pure fatty acid, a mixture of fatty acids, a pure fatty acid ester, a mixture of fatty acid esters and triglycerides, or a combination thereof.

43. The process of claim 39 wherein the engineered strain of yeast is an engineered strain of Candida tropicalis.

44. The process of claim 43 wherein the engineered strain of Candida tropicalis is selected from Candida tropicalis strains DP1, DP390, DP415, DP417, DP421, DP423, DP434 and DP436.

45. The process of claim 39 where the catalyst is selected from a salt or oxide of Li, Ca, Mg, Mn, Zn, Pb, Sb, Sn, Ge, and Ti.

46. The process of claim 45 wherein the salt is an acetate salt.

47. The process of claim 45 wherein the oxide is selected from an alkoxide or glycol adduct.

48. The process of claim 39 where the catalyst is selected from titanium tetraisopropoxide, titanium tetraethoxide, titanium tetrabutoxide and titanium tetrachloride.

49. The process of claim 39 where the catalyst is selected from stannous octanoate.

50. The process of claim 39 wherein the ω-hydroxyfatty acids is a member selected from the group consisting of ω-hydroxylauric acid (ω-OH-LA), ω-hydroxymyristic acid (ω-OHMA), ω-hydroxypalmitic acid (ω-OH-PA), ω-hydroxy palmitoleic acid (ω-OH-POA), ω-hydroxystearic acid (ω-OH-SA), ω-hydroxyoleic acid (ω-OH-OA), ω-hydroxyricinoleic acid (ω-OH-RA), ω-hydroxylinoleic acid (ω-OH-LA), ω-hydroxy-α-linolenic acid, (ω-OH-ALA), ω-hydroxy-γ-linolenic acid (ω-OH-GLA), ω-hydroxybehenic acid (ω-OH-BA) and ω-hydroxyerucic acid (ω-OH-EA).

51. The process of claim 39 wherein the one or more ω-hydroxyfatty acids or an ester thereof, or the one or more diacids or an ester thereof, is obtained by partial or complete hydrogenation of the feedstock prior to fermentation of the feedstock or partial or complete hydrogenation after fermentation of the feedstock.

52. The process of claims 1 and 39 wherein one or more α-hydroxyfatty acids or an ester thereof is added to prior to the heating step.

53. The process of claims 1 and 39 wherein the α-hydroxyfatty acid is selected from α-hydroxylauric acid (α-OH-LA), α-hydroxymyristic acid (α-OH-MA), αhydroxypalmitic acid (α-OH-PA), α-hydroxy palmitoleic acid (α-OH-POA), α-hydroxystearic acid (α-OH-SA), α-hydroxyoleic acid (α-OH-OA), α-hydroxyricinoleic acid (α-OH-RA), α-hydroxylinoleic acid (α-OH-LA), α-hydroxy-α-linolenic acid, (α-OH-ALA), α-hydroxy-γ-linolenic acid (α-OH-GLA), α-hydroxybehenic acid (α-OH-BA) and α-hydroxyerucic acid (αOH-EA).

54. The process of claim 53 wherein the α-hydroxyfatty acid is a lactone or macrolactone multimer of the α-hydroxyfatty acid.

55. (canceled)

56. (canceled)

57. (canceled)

58. (canceled)

59. (canceled)

60. (canceled)

61. (canceled)

62. The process of claim 58 wherein the filler particles have a mean particle diameter of about 1.5 to about 3.0 micrometers.

63. The copolyester formed by the process of claim 1.

64. A copolyester comprising one or more ω-hydroxyfatty acids produced by fermentation of a feedstock using an engineered yeast strain, one or more diacids, one or more diols in a molar amount equal to the one or more diacids, and optionally an additive that is a member selected from the group consisting of a branching agent, an ion-containing monomer, and a filler.

65. The copolyester of claim 64 wherein the one or more diacids is an ω-carboxyfatty acid obtained by fermentation of a feedstock using an engineered yeast strain.

66. The copolyester of claim 65 wherein the engineered strain of yeast is an engineered strain of Candida tropicalis.

67. The copolyester of claim 66 wherein the engineered strain of Candida tropicalis is selected from Candida tropicalis strains DP1, DP390, DP415, DP417, DP421, DP423, DP434 and DP436.

68. The copolyester of claim 64 wherein the one or more ω-hydroxyfatty acids is a member selected from the group consisting of ω-hydroxylauric acid (ω-OH-LA), ω-hydroxymyristic acid (ω-OH-MA), ω-hydroxypalmitic acid (ω-OH-PA), ω-hydroxy palmitoleic acid (ω-OH-POA), ω-hydroxystearic acid (ω-OH-SA), ω-hydroxyoleic acid (ω-OH-OA), ω-hydroxyricinoleic acid (ω-OH-RA), ω-hydroxylinoleic acid (ω-OH-LA), ω-hydroxy-α-linolenic acid, (ω-OH-ALA), ω-hydroxy-γ-linolenic acid (ω-OH-GLA), ω-hydroxybehenic acid (ω-OHBA) and ω-hydroxyerucic acid (ω-OH-EA).

69. The copolyester of claim 64 wherein the feedstock is partially or completely hydrogenating prior to fermentation.

70. (canceled)

71. (canceled)

72. (canceled)

73. (canceled)

74. (canceled)

75. (canceled)

76. (canceled)

77. The copolyester of claim 64 wherein the ion-containing monomer is an alkaline earth metal salt of a sulfonate group.

78. The copolyester of claim 64 wherein the amount of alkaline earth metal salt of a sulfonate group is from about 0.1 to about 5 mole percent by weight.

79. The copolyester of claim 64 wherein the filler is selected from calcium carbonate, non-swellable clays, silica, alumina, barium sulfate, sodium carbonate, talc, magnesium sulfate, titanium dioxide, zeolites, aluminum sulfate, diatomaceous earth, magnesium sulfate, magnesium carbonate, barium carbonate, kaolin, mica, carbon, calcium oxide, magnesium oxide, aluminum hydroxide and polymer particles.

80. The copolyester of claim 64 wherein the filler is selected from starches, such as thermoplastic starches or pregelatinized starches, microcrystalline cellulose, and polymeric beads.

81. The copolyester of claim 64 wherein the filler particles have a mean particle diameter of about 0.1 to about 10.0 micrometers.

82. The copolyester of claim 64 wherein the filler particles have a mean particle diameter of about 0.5 to about 5.0 micrometers.

83. The copolyester of claim 64 wherein the filler particles have a mean particle diameter of about 1.5 to about 3.0 micrometers.

84. A process for preparing a polymer blend which comprises:
(i) combining one or more copolyesters comprising ω-hydroxyfatty acid repeat units, one or more additional polymers and optionally a catalyst in a reaction vessel; and
(ii) providing sufficient energy to the combination of the one or more copolyesters comprising ω-hydroxyfatty acid repeat units, the one or more additional polymers and the optional catalyst in order to form a blend wherein the one or more additional polymers are grafted from the one or more copolyesters.

85. The process of claim 84 wherein the sufficient energy is provided by a melt reactive extrusion process.

86. The process of claim 84, wherein the weight ratio the ω-hydroxyfatty acid copolyester and the second polymer has from 1 to 99% by wt. of the ω-hydroxyfatty acid copolyester.

87. The process of claim 84, wherein the polyester blend involves a process of reactive extrusion that compatibilizes the blend.

88. The process of claim 84, wherein the catalyst is a radical initiator.

89. The process of claim 84, wherein the catalyst a transesterification catalyst.

90. The copolyester blend formed by the process of claim 84.

91. The copolyester of claim 1 wherein said copolyesters have inherent viscosities suitable for processing by injection molding, film blowing and formation of an article.

92. A film comprising a copolyester of claim 1.

93. A fiber comprising a copolyester of claim 1.

94. A molded article comprising a copolyester of claim 1.

95. A coating comprising a copolyester of claim 1.

96. A foam comprising a copolyester of claim 1.

97. The process of claim 20 wherein the branching agent is selected from glycerol, pentaerythritol, trimellitic anhydride, pyromellitic dianhydride, tartaric acid, 1,2,4-benzenetricarboxylic acid, (trimellitic acid), trimethyl-1,2,4-benzenetricarboxylate, 1,2,4-benzenetricarboxylic anhydride, (trimellitic anhydride), 1,3,5-benzenetricarboxylic acid, 1,2,4,5-benzenetetracarboxylic acid, (pyromellitic acid), 1,2,4,5-benzenetetracarboxylic dianhydride, (pyromellitic anhydride), 3,3′,4,4′-benzophenonetetracarboxylic dianhydride, 1,4,5,8-naphthalenetetracarboxylic dianhydride, citric acid, tetrahydrofuran-2,3,4,5-tetracarboxylic acid, 1,3,5-cyclohexanetricarboxylic acid, pentaerythritol, glycerol, 2-(hydroxymethyl)-1,3-propanediol, trimethylol propane, 2,2-bis(hydroxymethyl)propionic acid, epoxidized soybean oil and castor oil, or a mixture thereof.

98. The process of claim 39 wherein the branching agent is selected from glycerol, pentaerythritol, trimellitic anhydride, pyromellitic dianhydride, tartaric acid, 1,2,4-benzenetricarboxylic acid, (trimellitic acid), trimethyl-1,2,4-benzenetricarboxylate, 1,2,4-benzenetricarboxylic anhydride, (trimellitic anhydride), 1,3,5-benzenetricarboxylic acid, 1,2,4,5-benzenetetracarboxylic acid, (pyromellitic acid), 1,2,4,5-benzenetetracarboxylic dianhydride, (pyromellitic anhydride), 3,3′,4,4′-benzophenonetetracarboxylic dianhydride, 1,4,5,8-naphthalenetetracarboxylic dianhydride, citric acid, tetrahydrofuran-2,3,4,5-tetracarboxylic acid, 1,3,5-cyclohexanetricarboxylic acid, pentaerythritol, glycerol, 2-(hydroxymethyl)-1,3-propanediol, trimethylol propane, 2,2-bis(hydroxymethyl)propionic acid, epoxidized soybean oil and castor oil, or a mixture thereof.

99. The process of claim 39 wherein the ion-containing monomer is an alkaline earth metal salt of a sulfonate group.

100. The process of claim 20 wherein the filler is selected from calcium carbonate, non-swell able clays, silica, alumina, barium sulfate, sodium carbonate, talc, magnesium sulfate, titanium dioxide, zeolites, aluminum sulfate, diatomaceous earth, magnesium sulfate, magnesium carbonate, barium carbonate, kaolin, mica, carbon, calcium oxide, magnesium oxide, aluminum hydroxide and polymer particles.

101. The process of claim 39 wherein the filler is selected from calcium carbonate, non-swell able clays, silica, alumina, barium sulfate, sodium carbonate, talc, magnesium sulfate, titanium dioxide, zeolites, aluminum sulfate, diatomaceous earth, magnesium sulfate, magnesium carbonate, barium carbonate, kaolin, mica, carbon, calcium oxide, magnesium oxide, aluminum hydroxide and polymer particles.

102. The process of claim 20 wherein the filler is selected from starches, such as thermoplastic starches or pregelatinized starches, microcrystalline cellulose, and polymeric beads.

103. The process of claim 39 wherein the filler is selected from starches, such as thermoplastic starches or pregelatinized starches, microcrystalline cellulose, and polymeric beads.

104. The process of claim 59 wherein the filler particles have a mean particle diameter of about 0.1 to about 10.0 micrometers.

105. The process of claim 59 wherein the filler particles have a mean particle diameter of about 0.5 to about 5.0 micrometers.

106. The process of claim 59 wherein the filler particles have a mean particle diameter of about 1.5 to about 3.0 micrometers.

107. The copolyester formed by the process of claim 20.

108. The copolyester formed by the process of claim 39.
